(19) United States
(12) Patent Application Publication
(10) Pub. No.: US 2019/0147505 A1
(43) Pub. Date: May 16, 2019

(54) SYSTEM FOR ELECTRONIC MANAGEMENT OF FUNDRAISING CAMPAIGNS

(71) Applicant: Alexander Blass, (US)

(72) Inventor: Alexander Blass, Baltimore, MD (US)

(73) Assignee: Alexander Blass, Baltimore, MD (US)

(21) Appl. No.: 16/226,399

(22) Filed: Dec. 19, 2018

Related U.S. Application Data
(63) Continuation-in-part of application No. 12/295,487, filed on Jan. 13, 2010, now Pat. No. 10,198,733.
(60) Provisional application No. 60/787,159, filed on Mar. 30, 2006.
(60) Provisional application No. 60/787,158, filed on Mar. 30, 2006.

(51) Int. Cl. G06Q 30/02; G06Q 20/10; G06Q 50/00; G06Q 40/06

(52) U.S. Cl. CPC G06Q 30/0279; G06Q 40/06; G06Q 50/01; G06Q 20/10

(57) ABSTRACT

The present invention pertains to systems and methods for managing, creating, and conducting online personal or for-profit business fundraising campaigns. An exemplary embodiment of the present invention sets forth a system, method and computer program product for creating and managing online personal or for-profit business fundraising campaigns. In an exemplary embodiment, the method may include, e.g., but not limited to, receiving a request to establish a personal or for-profit business fundraising campaign from an initiator for benefit of a beneficiary at a central controller; receiving a plurality of donations at the controller, and disbursing at least a portion of the funds to the beneficiary.

### CROSS-REFERENCE TO RELATED APPLICATIONS

This application is a continuation in part patent application of U.S. patent application Ser. No. 12/295,487, filed Jan. 13, 2010, as a US National Phase Application of, and claims the benefit under 35 U.S.C Section 120 of, PCT International Application No PCT/US2007/007995 filed Mar. 30, 2007, published as WO 2007/123747 A2 on Nov. 1, 2007, claiming priority and benefit under 35 U.S.C. Section 119 (e) of U S. Provisional Patent Application No. 60/787,159, filed Mar. 30, 2006, and is related to U.S. Provisional Patent Application No. 60/787,158, filed Mar. 30, 2006, the contents of all of which are incorporated herein by reference in their entireties, and are of common assignee to the present invention.

### BACKGROUND OF THE DISCLOSURE

### Field of the Disclosure

The invention relates generally to charitable fundraising and more particularly to charitable donations and fundraising campaigns and systems.

### Related References

Giving charity is a tradition that has existed for a long time. Existing fundraising campaigns are typically operated by large non-profit organizations that collect money in aggregate and then disburse the money as they see fit. Thousands of fundraising organizations—some of which are classified as “non-profit”-exist which may raise donations from people and may then be entrusted to disburse the money judiciously to a “worthy cause” and people that need money. This conventional process is often very inefficient, as many of these fundraising organizations suffer from high overhead (including administrative and fundraising costs) or mismanagement.

One problematic outcome of this process is that many of these organizations may only ultimately spend or disburse around 50% of their charitable donation funds raised on the very programs that they were created to support. In other words, $0.50 of every $1 raised may be lost to, e.g., administrative tasks, salaries, fundraising costs, and the like. Another problem is that when one donates money in this conventional method, it is impossible to know where the money ends up, and one may not specify whom in need-if anyone-actually receives the money. Another problem is that individuals in dire need do not conventionally have a convenient way to request funds they require. Stated another way, because the term “worthy cause” is subjective and in the eye of the beholder, would-be donors are limited only to helping causes that someone else, or an organization, has vetted and deems “worthy.” For example, while one may know that one's money may broadly be going to help victims of a natural disaster, the destination of the money is very broad and non-specific Consequently, there is a huge disconnect between the giver and the receiver. Nevertheless, this dynamic has remained the status quo. The present invention brings efficiency to this very inefficient and fragmented process of fundraising and charitable giving.

### SUMMARY OF THE DISCLOSURE

Although described in terms of a method, this application contemplates systems, methods, and computer program products for providing management of fundraising campaigns. An exemplary embodiment of the present invention sets forth a fundraising campaign management system and clearinghouse platform designed for networks such as, e.g., but not limited to, local area networks (LANs), wide area networks (WANs), wired networks, wireless networks, the Internet, World Wide Web, mobile devices and interactive television In an exemplary embodiment the fundraising campaign management system and clearinghouse platform may be focused on consumer/person-to-person fundraising campaigns In another exemplary embodiment, the system may be used for organizational fundraising campaigns such as, e.g., but not limited to, a charity, a business, non-profit, association, etc. The invention may provide a platform for the millions of individual people around the world in dire financial need, due to various reasons—such as, e.g, but not limited to, natural disasters, student loans, divorce, medical bills, unemployment, adoption, and/or many others—to initiate their own personal charity fundraising campaign. An initiator may create a campaign for the benefit of an individual (defined broadly such as, e.g., but not limited to, a person, a family, an entity, someone raising money on their own behalf, or in the name of a corporation, business, group, association, or non-profit organization) referred to as a beneficiary. In some cases the fundraising campaign service provider may initiate a campaign. According to an exemplary embodiment, the fundraising campaign may be listed on a website, to be viewed by potential donors who may be looking to directly contribute to an individual or cause they deem worthy. According to an exemplary embodiment of the invention, individuals may logon to the system and may initiate their own personal charity fundraising campaigns, and multiple of these campaigns may occur concurrently. Each fundraising campaign may be immediately posted and available to the browsing public and potential donors, or may require validation, approval and/or activation by the fundraising campaign service provider. An initiator of a fundraising campaign may bolster the initiator's credibility with potential donors by optionally providing a detailed description of the initiator's need and circumstances as well as any supporting evidence such as, e.g., but not limited to, photos and/or documents that may further demonstrate the financial need of the initiator, which may be made accessible for viewing by, e.g, potential donors, and/or the public. An initiator of a fundraising campaign may further bolster the initiator's credibility with potential donors by undergoing a third-party identity verification and/or authentication process, and other users and/or potential donors may be able to distinguish between users who have or have not had their identity verified successfully. Visitors and/or potential donors may browse and/or perform searches on a plurality of personal fundraising campaigns by a variety of criteria or parameters, such as, e.g, but not limited to, theme and/or category of cause of financial need, initiator age, initiator gender, initiator location, initiator ethnicity, initiator religion, initiator funds requested, and/or initiator funds raised, for example. By browsing and/or searching as described above, visitors and/or potential donors may identify specific fundraising campaigns of interest to them, may read the details of any personal appeals that may spark potential donor curiosity and/or may resonate with the potential donor, etc The donor may then directly donate money to any fundraising campaign, via the fundraising management system. In an exemplary embodiment, the donor may create and register an account with the fundraising service provider, or may donate without creating and registering an account, and the donor may have the ability to choose how much, if any, information about the donor is given to the recipient. The donations may be disbursed to the selected person or persons by the fundraising service provider, which may charge any of a fee, a fundraising campaign initiation fee, a one-time or recurring listing fee, and/or an administrative fee as funds are raised and/or disbursed. The fundraising service provider may disburse all or part of donations earmarked to the beneficiary of a particular fundraising campaign either immediately as donations are received, or in aggregate at a later time. In another exemplary embodiment, the funds may immediately pass directly from the donor to the initiator, based on disbursement information collected from the initiator by the fundraising service provider.

Other features and variations may be included, such as, e.g., but not limited to, book marking particular fundraising campaign listings for later viewing, emailing of links to others by initiators, donors, and/or public visitors, and rewarding donors with occasional raffles with monetary or non-monetary prizes

Recognition of user donations may be performed in various ways, including, e.g., but not limited to, a stock market style scrolling “ticker,” and/or a scoreboard list displaying donors by recency, volume of donations, cumulative value of donations, by particular time period (such as day, week, month, year, or total), and/or may be further specified by geography and/or other parameters, for example. A visual icon and/or other notation distinguishing levels of cumulative giving and/or giving frequency by a donor may be offered as well, as well as awards and/or gifts based on cumulative giving. As an additional incentive and motivator for potential donors, donors may be able to advertise their own product or service on the fundraising service provider website, and the location, size and scope of the advertisement may be related to their donation. This advertisement may be in various forms, such as, e.g., but not limited to, an Internet hyperlink to another website, a descriptive text advertisement, a graphical advertisement, a video advertisement, and/or an audio advertisement.

Users of the fundraising management system, including donors, donees, initiators, beneficiaries, and/or others, may optionally publish a viewable profile of themselves that may include such information as, e.g., but not limited to, user name, real name, location, photographs, cumulative donations given and/or received, recent donations given and/or received, user comments, and links to specific fundraising campaign listings which may or may not include their own.

An exemplary embodiment of the present invention sets forth a system, method and computer program product for creating and managing online personal fundraising campaigns. In an exemplary embodiment, the method may include receiving a request to establish a personal fundraising campaign from an initiator for benefit of a beneficiary at a central controller; receiving a plurality of donations at the controller; and disbursing at least a portion of the funds to the beneficiary.

In another exemplary embodiment, the method may include where the initiator is at least one of a fundraising service provider and/or a beneficiary.

In an exemplary embodiment, the method may include where the central controller is a fundraising service provider.

In an exemplary embodiment, the method may include where a plurality of fundraising campaigns occur concurrently.

In an exemplary embodiment, the method may further include charging at least one of a fee, an initiation fee to the initiator to initiate a fundraising campaign, charged by the fundraising service provider; a listing fee; a recurring (periodic) fee to the initiator, charged by the fundraising service provider; a transactional/administrative fee per donation, which may be a flat fee and/or percent of the donation, charged by the fundraising service provider and may be calculated and displayed in a transparent fashion to the donor, initiator, beneficiary, and/or the browsing public per donation; and/or a fundraising campaign completion fee paid by at least one of the initiator, the beneficiary, and/or out of the proceeds of the fundraising campaign, charged by the fundraising service provider when the fundraising campaign is completed and wherein the fundraising campaign completion fee may include at least one of a flat rate and/or an amount related to or percentage of the amount of money raised by the fundraising campaign

In an exemplary embodiment, the method may include where the beneficiary may include a plurality of beneficiaries.

In an exemplary embodiment, the method may further include at least one of receiving documentary evidence; receiving evidence of financial need from at least one of: the initiator, potential beneficiary, and/or the beneficiary; providing the evidence to a user; providing at least one of information, documentation, and/or photographs that support the claim of financial need; conducting third party identity verification/authentication of users; conducting third party identity verification/authentication of at least one of: the initiator, potential beneficiary, and/or beneficiary; availing the outcome of said third party identity verification/authentication to other users; and/or distinguishing users in some fashion whose identities have been verified/authenticated.

In an exemplary embodiment, the method may further include receiving search queries from visitors searching fundraising campaign listings by at least one criterion.

In an exemplary embodiment, the method may further include providing preferential placement on a website for a fundraising campaign based on a criterion may include at least one of: an initiation fee level; a commission level; an auction bid level, an activity level: and/or fundraising campaign popularity.

In an exemplary embodiment, the method may include where terms and conditions of a particular fundraising campaign are defined by at least one of the initiator and/or beneficiary.

In an exemplary embodiment, the method may further include at least one of selecting by the initiator from a plurality of monetary currencies in which to conduct the fundraising campaign, and/or a donor, participates in a foreign currency fundraising campaign by converting the native currency of the donor into the fundraising campaign currency via an exchange rate.

In an exemplary embodiment, the method may include where the beneficiary of the fundraising campaign is not predetermined.

In an exemplary embodiment, the method may include where a donor selects at least one of multiple fundraising campaigns and/or a fundraising category, and/or particular donee criteria, as the potential recipients and/or beneficiaries of the donation, unable to specify the ultimate recipient and/or beneficiaries of the donation, and the fundraising service provider determines one or more fundraising campaigns to receive the donation, or a ratio split and/or allocation thereof

In an exemplary embodiment, the method may include where a plurality of donees are pooled and donations are randomly assigned to donees by the fundraising service provider, and the fundraising service provider may inform the donor of the assignment.

In an exemplary embodiment, the method may include where prior to the activation of a fundraising campaign, the fundraising service provider may first review and authorize the campaign, and/or at least one of the public and users may first review it and vote as to whether or not the listing should be authorized and activated.

In an exemplary embodiment, the method may include where the fundraising service provider disburses the at least a portion of donations to at least one of a donee, the initiator, and/or the beneficiary.

In an exemplary embodiment, the method may include where the disbursement is performed at least one of electronically, by electronic funds transfer (EFT), as soon as donations are received, in a batch process at a later time, at a periodic time interval, at a time when the donee requests the disbursement, and/or in a manual payment disbursement process.

In an exemplary embodiment, the method may further include at least one of depositing and then disbursing donations; not depositing and then disbursing donations; forwarding at least a portion of the donation(s) to at least one of the beneficiary, and/or the initiator, based upon information collected from the beneficiary, and/or paying donor money directly from donor to initiator.

In an exemplary embodiment, the method may further include recognizing user donations including at least one of: displaying most recent donations which may include photos of the donor, initiator, and/or beneficiary, providing a scoreboard showing top donors including optional personal information and/or a photo, by at least one of recency, volume of donations, cumulative value of donations by particular time period including at least one of day, week, month, year, and/or total, by geography, and/or by other parameters; providing a cumulative giving scoreboard by at least one of a city, a state, a country, and/or a region: providing one or more visual icons and/or other notation distinguishing cumulative giving at particular thresholds of frequency and/or giving total; providing a wall where a donor may post a public message of support for the initiator and/or beneficiary along with an optional photo and/or link to a profile page of at least one of, the donor, the initiator and/or the beneficiary, providing the initiator and/or the beneficiary the ability to post a corresponding public thank you note with an optional photo for the donation on the beneficiary's donor wall and/or on the wall of the donor with at least one of a link back to the beneficiary's page, and/or a communication if the donor optionally provides sufficient personal information, via at least one of email, postal mail, instant message, alert, and/or other communication; and/or providing a stock market style scrolling “ticker.”

In an exemplary embodiment, the method may further include publishing a profile of users including at least one of a name, a location, a photo, cumulative giving, recent giving, and/or comments.

In an exemplary embodiment, the method may further include sending by at least one of browsing public, donors and/or initiators, a hyperlink via email to notify others of the fundraising campaign, and/or book marking particular fundraising campaigns for future viewing.

In an exemplary embodiment, the method may further include conducting raffles in which at least one donor may participate.

In an exemplary embodiment, the method may include where the terms and conditions may include at least one of selecting a duration of the fundraising campaign based on at least one of reaching a threshold amount of funds raised, a fixed calendar date/time, and/or expiration of a period of time; selecting a party responsible for any administration fee: selecting a start date and/or time of a fundraising campaign, and/or selecting a cancellation term.

In an exemplary embodiment, the method may further include at least one of choosing a list of potential beneficiaries by the public, the fundraising service provider, and/or by the donors.

In an exemplary embodiment, the method may further include listing and/or voting on a plurality of potential beneficiaries by the public and/or donors, and these votes may include are uniformly weighted, and/or are weighted by donation amount paid by the donor.

In an exemplary embodiment, the method may further include determining a list of one or more potential beneficiaries in an auction process, with those seeking to be beneficiaries bidding on a chance to be listed as the one or more potential beneficiaries.

In an exemplary embodiment, the method may further include providing an affiliate program whereby others may promote and/or refer new users to the service via their own websites, blogs, social network, email lists, and/or other platforms, in which these referrals may be tracked and credited to the referee and compensated via a flat rate, a commission of fees generated by the referred users, and/or a bonus based on volume of referrals, fees generated, and/or by donation volume or cumulative contribution amounts generated

In an exemplary embodiment, an exemplary system of electronically creating, electronically managing, and electronically hosting a plurality of online electronic fundraising campaigns and of electronically providing for rapid distribution of funds, and transaction state, by electronic initiation of electronic distribution of funds raised, can include: at least one computer memory; and at least one computer processor, coupled to the at least one memory, the at least one computer processor configured to electronically: receive an electronic request to create a new electronic fundraising campaign including social networking, electronic scoreboard, and electronic initiation of disbursement process; create the new electronic fundraising campaign can include: wherein the at least one computer processor is configured to electronically: receive and check electronic account details for an account of the new electronic fundraising campaign; determine if the account details of the account correspond to an existing user account, and at least one, or more, of: create a new account if the account is not an existing user account; or receive a username and password of the account for an existing user account and verify the received username and the password of the account of the existing user account; receive monetary amount sought, title, description categories, themes and listing details of the new electronic fundraising campaign; receive optional upload of files or images of the new electronic fundraising campaign; receive input of, verify, process billing information associated with the new electronic fundraising campaign; receive acceptance of listing agreement of the new electronic fundraising campaign; receive at least one electronic address for notification of the new electronic fundraising campaign; receive electronic request to access a user profile of a user computing device of the system; provide access to the user profile in response to the electronic request to access the user profile; receive an electronic fundraising campaign search request from a search user computing device of the system; display search result to the search user computing device of the system; receive at least one, or more of: receive any bookmark and store in a related user account; receive at least one donation from a donor user computing device to contribute funds to the new electronic fundraising campaign, wherein the at least one donation includes at least one, or more, of: receive an electronic request to make an anonymous donation to the new electronic fundraising campaign; receive an electronic request to make an eponymous donation to the new electronic fundraising campaign; or receive an electronic request to make a gift donation to the new electronic fundraising campaign; or receive an electronic request for an electronic link to the new fundraising campaign; receive any request to display data relating to donors computing devices; display in response to the any request to display data relating to donors computing device, a donor display result; receive at least one social network wall post related to the new electronic fundraising campaign; display the at least one social network wall post related to the new electronic fundraising campaign; accumulate a plurality of the at least one donation into accumulated donations; create an electronic scoreboard of the accumulated donations; and initiate the electronic disbursement process and maintain transaction state of electronic distribution of at least a portion of the funds raised from the new electronic fundraising campaign; wherein the initiation of the electronic disbursement process is performed at least one, or more, of: electronically, at least one, or more, of: as soon as funds are received, in a batch process at a later time, at a periodic time interval, at a time when a donor computing device, initiator computing device, beneficiary computing device, payment processor computing device, online fundraising service provider computing device, or recipient computing device requests the disbursement, or in a payment disbursement process; or electronically, by electronic funds transfer (EFT), at least one, or more, of: as soon as funds are received, in a batch process at a later time, at a periodic time interval, at a time when the donor computing device, initiator computing device, beneficiary computing device, payment processor computing device, online fundraising service provider computing device, requests the disbursement, or in a payment disbursement process; and display on a graphical user interface the transaction state of the electronic distribution.

According to another exemplary embodiment, the system can further include: receive any third party identity authentication electronic request; perform the electronic third party identity authentication in response to the any third party identity authentication electronic request; and display a third party identity authentication electronic result in response to the any third party identity authentication electronic request, and update the user account with the third party identity authentication electronic result in response to the any third party identity authentication electronic request.

According to another exemplary embodiment, the system can include: where the third party identity authentication electronic result includes a social network wall post from at least one user computing device. According to another exemplary embodiment, the system can include: where if determined to not be an existing account, the create the new account includes wherein the at least one computer processor is configured to electronically, at least one, or more, of: receive electronic input of new account information of the account; verify the electronic input of new account information of the account; receive electronic acceptance of user agreement of the account; send electronic confirmation request of new account to the account; or receive from the account electronic confirmation of the new account.

According to another exemplary embodiment, the system can include: where the create an electronic scoreboard of the accumulated donations includes wherein the at least one computer processor is configured to electronically, at least one, or more, of: provide a textual representation of the accumulated donations; or provide a graphical representation of the accumulated donations; provide at least one, or more, of: provide at least one electronic tool which can include computer instruction code; or provide at least one electronic tool to electronically publicize, or electronically promote, the new electronic fundraising campaign.

According to another exemplary embodiment, a computer implemented method of electronically creating, electronically managing, and electronically hosting a plurality of online electronic fundraising campaigns and of electronically providing for rapid distribution of funds, and transaction state, by electronic initiation of electronic distribution of funds raised, can include electronically: receiving, by at least one computer processor coupled to at least one memory, an electronic request to create a new electronic fundraising campaign including social networking, electronic scoreboard, and electronic disbursement; creating, by the at least one computer processor, the new electronic fundraising campaign can include: receiving, by the at least one computer processor, electronically and checking electronically electronic account details for an account of the new electronic fundraising campaign; determining electronically, by the at least one computer processor, if the account details of the account correspond to an existing user account, and at least one, or more, of: creating electronically, by the at least one computer processor, a new account if the account is not an existing user account; or

receiving electronically, by the at least one computer processor, a username and password of the account for an existing user account and verifying electronically, by the at least one computer processor, the received username and the password of the account of the existing user account; receiving electronically, by the at least one computer processor, monetary amount sought, title, description categories, themes and listing details of the new electronic fundraising campaign; receiving electronically, by the at least one computer processor, optional upload of files or images of the new electronic fundraising campaign; receiving electronically, by the at least one computer processor, input of, verify, process billing information associated with the new electronic fundraising campaign; receiving electronically, by the at least one computer processor, acceptance of listing agreement of the new electronic fundraising campaign; receiving electronically, by the at least one computer processor, at least one electronic address for notification of the new electronic fundraising campaign; receiving electronically, by the at least one computer processor, electronic request to access a user profile of a user computing device of the system; providing electronically, by the at least one computer processor, access to the user profile in response to the electronic request to access the user profile; receiving electronically, by the at least one computer processor, an electronic fundraising campaign search request from a search user computing device of the system; displaying electronically, by the at least one computer processor, search result to the search user computing device of the system; receiving electronically, by the at least one computer processor, at least one, or more of: receiving electronically, by the at least one computer processor, any bookmark and store in a related user account; receiving electronically, by the at least one computer processor, at least one donation from a donor user computing device to contribute funds to the new electronic fundraising campaign, wherein the at least one donation includes at least one, or more, of: receiving electronically, by the at least one computer processor, an electronic request to make an anonymous donation to the new electronic fundraising campaign; receiving electronically, by the at least one computer processor, an electronic request to make an eponymous donation to the new electronic fundraising campaign; or receiving electronically, by the at least one computer processor, an electronic request to make a gift donation to the new electronic fundraising campaign; or receiving electronically, by the at least one computer processor, an electronic request for an electronic link to the new fundraising campaign; receiving electronically, by the at least one computer processor, any request to display data relating to donors computing devices; displaying electronically, by the at least one computer processor, in response to the any request to display data relating to donors computing device, a donor display result; receiving electronically, by the at least one computer processor, at least one social network wall post related to the new electronic fundraising campaign; displaying electronically, by the at least one computer processor, the at least one social network wall post related to the new electronic fundraising campaign; accumulating electronically, by the at least one computer processor, a plurality of the at least one donation into accumulated donations; creating electronically, by the at least one computer processor, an electronic scoreboard of the accumulated donations; and initiating electronically, by the at least one computer processor, an electronic disbursement method or process and maintaining electronically transaction state of electronic distribution of at least a portion of the funds raised from the new electronic fundraising campaign; wherein the initiating the electronic disbursement method or process is performed at least one, or more, of: electronically directly, or electronically indirectly between a plurality of entities; electronically, at least one, or more, of: as soon as funds are received, in a batch process at a later time, at a periodic time interval, at a time when a donor computing device, initiator computing device, beneficiary computing device, payment processor computing device, online fundraising service provider computing device, or recipient computing device requests the disbursement, or in a payment disbursement process; or electronically, by electronic funds transfer (EFT), at least one, or more, of: as soon as funds are received, in a batch process at a later time, at a periodic time interval, at a time when the donor computing device, initiator computing device, beneficiary computing device, payment processor computing device, online fundraising service provider computing device, requests the disbursement computing device, or in a payment disbursement process; and displaying electronically, by the at least one computer processor, on a graphical user interface the transaction state of the electronic distribution.

According to another exemplary embodiment, a non-transitory computer readable medium can be included having stored thereon instructions for causing one or more processing units to execute the above method.

Various alternative exemplary embodiments can include, e.g., but not limited to:

According to an exemplary embodiment, a computer-implemented method of electronically creating, electronically managing, and electronically hosting a plurality of online electronic fundraising campaigns and of providing for rapid distribution of funds, and transaction state of electronic initiation of electronic distribution of funds raised, can include: under control of a fundraising electronic social networking system of an online electronic fundraising service provider system of an online fundraising service provider, wherein the fundraising electronic social networking system includes: at least one computer processor, and at least one computer memory device, and wherein the fundraising electronic social networking system is coupled to at least one electronic communications network, and wherein the at least one computer processor is configured to: display, by the at least one electronic computer processor, a graphical user interface for at least one online electronic fundraising campaign; initiate, by the at least one electronic computer processor, an electronic disbursement process of at least a portion of funds by at least one electronic transaction, initiated by the online electronic fundraising service provider; and wherein the computer-implemented method includes: electronically receiving, by the at least one electronic computer processor, an electronic request to create at least one online electronic fundraising campaign from an electronic initiator social networking computing system of an initiator computing device of an initiator over the at least one electronic communications network, wherein the initiator computing device of the initiator includes at least one or more of: a) an individual initiator computing device not a non-profit entity, b) a group initiator computing device not a non-profit entity, or c) a for-profit initiator computing device, for benefit of a beneficiary having a beneficiary computing device, wherein the beneficiary computing device of the beneficiary includes at least one or more of: a) an individual beneficiary computing device of a not a non-profit entity, b) a group beneficiary computing device of a not a non-profit entity, or c) a for-profit beneficiary computing device; and wherein the electronic initiator social networking computing system includes at least one or more of: an electronic mobile device; an electronic interactive television device; a wired electronic communications device; a wireless electronic communications device; an electronic social networking computing system; an electronic social networking system web-browser based computing system; an electronic handheld social networking computing system; an electronic telephony device; or an electronic streaming technology device; electronically creating, by the at least one electronic computer processor, at least one online electronic fundraising campaign page for the at least one created online electronic fundraising campaign for display on the graphical user interface, in response to the electronic request to create the online electronic fundraising campaign from the initiator for the benefit of the beneficiary having the beneficiary computing device; electronically displaying, by the at least one electronic computer processor, the at least one online electronic fundraising campaign page on at least one graphical user interface; electronically creating, by the at least one electronic computer processor, at least one online electronic social network wall, associated with the at least one created online electronic fundraising campaign and the at least one online electronic fundraising campaign page created, wherein the at least one online electronic social network wall is configured to electronically receive input in the at least one graphical user interface, by the at least one electronic computer processor, and electronically provide for electronic display, by the at least one electronic computer processor on the at least one graphical user interface, of any online electronic computer social network wall posts electronically received, by the at least one electronic computer processor, over the electronic communication network from any of a plurality of electronic social networking system computing devices of each of a plurality of users to the at least one created online electronic fundraising campaign, wherein each of the plurality of electronic social networking system computing devices comprise at least one or more of: an electronic mobile device; an electronic interactive television device; a wired electronic communications device; a wireless electronic communications device; an electronic social networking system web-browser based program; a handheld electronic social networking system computing device; an electronic telephony device; or a streaming technology device, wherein the online electronic computer social network wall posts electronically received by the at least one electronic computer processor, comprise at least one or more of: an electronic donor post can include at least one or more of: a social media wall post from a donor computing device to the at least one created online electronic fundraising campaign; an electronic donation from the donor computing device; an electronic computer social network wall post of a message of support from the donor computing device for the beneficiary computing device; or an electronic computer social network wall post promoting the at least one created online electronic fundraising campaign; at least one electronic computer social network wall post from at least one or more of: the beneficiary computing device; the initiator computing device; a registered user computing device; a user computing device; a visitor computing device; member of browsing public computing device; or one or more of the donors computing devices; an electronic beneficiary post can include at least one or more of: an online electronic computer social network wall post from the beneficiary computing device; an online electronic computer social network wall post promoting the at least one created online fundraising campaign; an online electronic computer social network wall post of an electronic message from the beneficiary computing device; or an online electronic computer social network wall post of a thank you from the beneficiary computing device; or an electronic initiator post can include at least one or more of: an online electronic computer social network wall post from the initiator computing device; an online electronic computer social network wall post promoting the at least one created online fundraising campaign; an online electronic computer social network wall post of an electronic message from the initiator computing device; an online electronic computer social network wall post of a thank you from the initiator computing device; or an online electronic computer social network wall post of an electronic message of support from the initiator computing device of the at least one electronically created online electronic fundraising campaign; electronically receiving, by the at least one electronic computer processor, data indicative of a plurality of funds from the plurality of electronic social networking system computing devices of the plurality of users, wherein each of the plurality of the electronic social networking system computing devices is coupled to the fundraising electronic social networking system of the online electronic fundraising service provider system by the at least one electronic communications network; and electronically computing and electronically displaying, by the at least one electronic computer processor, on the at least one online electronic fundraising campaign page of the at least one electronically created online electronic fundraising campaign, an online electronic computer displayable scoreboard associated with the at least one electronically created online electronic fundraising campaign, wherein the online electronic computer displayable scoreboard includes: an online electronic computer displayable cumulative value of funds raised from the plurality of users computing devices of one or more of the at least one electronically created online electronic fundraising campaign, wherein the online electronic computer displayable cumulative value is computed by at least one or more of: at least one threshold, a giving total, a frequency, or at least one particular time period can include at least one or more of: a day, a week, a month, a year, or a total time period; and wherein the electronically displaying includes: electronically displaying, by the at least one electronic computer processor, on the graphical user interface the online electronic computer displayable cumulative value and the online electronic computer displayable scoreboard; electronically enabling, by the at least one electronic computer processor, collecting from the initiator computing device or the beneficiary computing device disbursement information of the initiator or beneficiary to receive the at least a portion of funds electronically via the electronic disbursement process from the plurality of users computing devices of the at least one electronically created online electronic fundraising campaign; electronically initiating the electronic disbursement process, by the at least one electronic computer processor, of the at least a portion of the funds raised electronically from the at least one electronically created online electronic fundraising campaign according to the disbursement information collected from the beneficiary computing device of the beneficiary or initiator computing device of the initiator; wherein the initiating of the electronic disbursement process is performed at least one or more of: electronically, by the at least one electronic computer processor, at least one or more of: as soon as funds are received, in a batch process at a later time, at a periodic time interval, at a time when the donor computing device, the initiator computing device, the beneficiary computing device, payment processor computing device, the online electronic fundraising service provider system, or recipient computing device requests the disbursement, or in the payment disbursement process; or electronically, by the at least one electronic computer processor, by electronic funds transfer (EFT), at least one or more of: as soon as funds are received, in a batch process at a later time, at a periodic time interval, at a time when the donor, initiator, beneficiary, payment processor, online electronic fundraising service provider, requests the disbursement, or in the payment disbursement process; and wherein the electronically initiating of the electronic disbursement process includes: electronically displaying, by the at least one electronic computer processor, on the graphical user interface the transaction state of the initiation of the electronic disbursement, by the at least one electronic transaction; electronically receiving, by the at least one computer processor, at least one electronic search query from at least one visitor computing device searching, by the at least one computer processor, at least one listing of at least one or more of the electronically created online electronic fundraising campaign by at least one criterion; and at least one or more of: electronically providing, by the at least one processor, at least one electronic tool which can include distributable computer instruction code for at least one or more of: browsing public computing device, registered user computing device, user computing device, contributor computing device, beneficiary computing device, donor computing device, or initiator computing device, or electronically providing, by the at least one processor, at least one electronic tool to electronically publicize or electronically promote, the at least one or more of the electronically created online electronic fundraising campaign hosted by the online fundraising service provider, on the graphical user interface can include at least one or more of: at least one website, at least one blog, or at least one mobile device; and electronically creating, by the at least one electronic computer processor, the online electronic computer displayable scoreboard includes: electronically displaying, by the at least one electronic computer processor, on the graphical user interface, by the at least one computer, at least one or more of: an electronic computer displayable graphic element representative of; or an electronic computer displayable text representation of, the online electronic computer displayable cumulative value of the funds raised, according to one exemplary embodiment.

According to an exemplary embodiment, the method can include where the receiving the request to create the at least one online fundraising campaign from the initiator includes at least one or more of: receiving, by the at least one computer processor, the request to create the at least one online fundraising campaign for the benefit of a beneficiary, wherein the beneficiary is also the initiator; receiving, by the at least one computer processor, the request to create the at least one online fundraising campaign from the online fundraising service provider; receiving, by the at least one computer processor, the request to create the at least one online fundraising campaign from the beneficiary; or receiving, by the at least one computer processor, the request to create the at least one online fundraising campaign from an individual person beneficiary, according to one exemplary embodiment.

According to an exemplary embodiment, the method can further include: receiving, by the at least one computer processor, at least one additional of the requests, each of the at least one additional of the requests to establish an associated at least one or more of the created online fundraising campaigns at the online electronic fundraising service provider system or the fundraising electronic social network system, or any of the plurality of electronic social networking system computing devices, and providing, by the at least one computer processor, information of the at least one created online fundraising campaigns, can include at least one or more of: providing, by the at least one computer processor, a list of the at least one created online fundraising campaign; receiving, by the at least one computer processor, at least one query can include at least one criterion for the at least one created online fundraising campaign; or providing, by the at least one computer processor, a response to the at least one query can include the at least one created online fundraising campaign corresponding to the at least one query, according to one exemplary embodiment.

According to an exemplary embodiment, the method can include where the a plurality of the created online fundraising campaigns are hosted, by the at least one computer processor, and occur during a time period at least one or more of: simultaneously; at least partially simultaneously; overlapping; at least partially overlapping; at least partially concurrently; or concurrently, according to one exemplary embodiment.

According to an exemplary embodiment, the method can further include: charging, by the at least one computer processor, at least one or more of: a fee; an initiation fee to the initiator to initiate a given one of the created online fundraising campaigns, charged by the online fundraising service provider; a listing fee; a recurring periodic fee to the initiator, charged, by the at least one computer processor, by the online fundraising service provider; a transactional administrative fee per donation, contribution, or transaction, the transactional administrative fee includes at least one or more of a flat fee, or a percentage of the donation, contribution, or transaction, wherein the transactional administrative fee is being charged, by the at least one computer processor, by the online fundraising service provider, and wherein the transactional administrative fee is calculated by, by the at least one computer processor, and displayed in, by the at least one computer processor, a transparent fashion to at least one or more of the donor, contributor, party to the transaction, the initiator, the beneficiary, or browsing public per donation; or an online fundraising campaign completion fee collected, by the at least one computer processor, as paid at least one or more of: by at least one or more of the initiator, or the beneficiary, or out of the proceeds of the at least one or more of the created online fundraising campaign, or charged, by the at least one computer processor, by the online fundraising service provider when the at least one or more of the created online fundraising campaign is completed, wherein the online fundraising campaign completion fee includes at least one or more of: a flat rate; or an amount related to, or percentage of, including calculating, by the at least one computer processor, the amount of money raised by the at least one or more of the created online fundraising campaign, according to one exemplary embodiment.

According to an exemplary embodiment, the method can further include at least one or more of: receiving, by the at least one computer processor, documentary evidence; receiving, by the at least one computer processor, evidence of financial need from at least one or more of: the initiator, potential beneficiary, or the beneficiary; providing, by the at least one computer processor, the evidence to a user; providing, by the at least one computer processor, at least one or more of: information, documentation, or photographs that support the claim of financial need; conducting, by the at least one computer processor, third party identity verification or authentication of users; conducting, by the at least one computer processor, third party identity verification or authentication of at least one or more of: the initiator, potential beneficiary, or the beneficiary; availing, by the at least one computer processor, the outcome of the third party identity verification or authentication to other users; receiving, by the at least one computer processor, authentication data from at least one user; processing, by the at least one computer processor, user authentication of the at least one user; or distinguishing, by the at least one computer processor, users in some fashion whose identities have been verified or authenticated, according to one exemplary embodiment.

According to an exemplary embodiment, the method can further include providing, by the at least one computer processor, preferential placement for at least one or more of the at least one created online fundraising campaigns based on a criterion can include at least one or more of: an initiation fee level; a commission level; an auction bid level; an activity level; or fundraising campaign popularity, according to one exemplary embodiment.

According to an exemplary embodiment, the method can further include displaying, by the at least one computer processor, terms and conditions of a particular one of the at least one or more of the created online fundraising campaign are defined by at least one or more of: the initiator, or the beneficiary, according to one exemplary embodiment.

According to an exemplary embodiment, the method can further include at least one or more of: selecting, by the at least one computer processor, by the initiator from a plurality of monetary currencies at least one or more of: in which to conduct the at least one or more of the created online fundraising campaign, or in which a donor participates in a foreign currency fundraising campaign by converting the native currency of the donor into the fundraising campaign currency via an exchange rate, according to one exemplary embodiment.

According to an exemplary embodiment, the method can include where the beneficiary of the fundraising campaign is not predetermined, according to one exemplary embodiment.

According to an exemplary embodiment, the method can include where the method includes: receiving a donor selection, by the at least one computer processor, at least one or more of: at least one fundraising campaign; at least one fundraising category; or at least one particular donee criterion, as the at least one or more of potential recipient or beneficiary of the donation, wherein the donee is unable to specify, by the at least one computer processor, the ultimate at least one or more of recipient or beneficiary of the donation, and the online fundraising service provider determining, by the at least one computer processor, one or more of the at least one or more of the established online person fundraising campaign receiving the donation, or a ratio split or allocation thereof, according to one exemplary embodiment.

According to an exemplary embodiment, the method can include where the further can include: receiving, by the at least one computer processor, a plurality of unassigned donations of donors, wherein the receiving, by the at least one computer processor, the unassigned donations are donated for the not predetermined beneficiary; accepting, by the at least one computer processor, the unassigned donations; pooling, by the at least one computer processor, the unassigned donations; assigning, by the at least one computer processor, the unassigned donations to at least one donee beneficiary by the online fundraising service provider; and informing, by the at least one computer processor, the donor of the assignment to the at least one donee beneficiary, by the fundraising service, according to one exemplary embodiment.

According to an exemplary embodiment, the method can include where the online electronic fundraising service provider system initiates disbursing electronically, by the at least one processor, using the electronic disbursement process and the disbursement information, the at least a portion of funds to at least one or more of: a donee, the initiator, or the beneficiary, according to one exemplary embodiment.

According to an exemplary embodiment, the method can further include the at least one or more of: depositing, by the at least one processor, and electronically disbursing, by the at least one processor, funds; not depositing, by the at least one processor, and electronically disbursing, by the at least one processor, funds; forwarding, by the at least one processor, electronically at least a portion of the fund(s) to at least one or more of: the beneficiary, or the initiator, based upon information collected, by the at least one processor, from the beneficiary or initiator; paying electronically, by the at least one processor, funds from donor or contributor, to initiator or beneficiary; prior to activation of the at least one online fundraising campaign, at least one or more of: reviewing or authorizing, by the at least one processor, the online fundraising campaign; reviewing, by the at least one processor, the at least one online fundraising campaign; reviewing, by the at least one or more of the public or user, the at least one online fundraising campaign, or receiving, by the at least one processor, at least one vote as to whether or not the at least one online fundraising campaign should be authorized and activated; or receiving, by the at least one processor, a request or authorization to receive funds from at least one or more of: a donor, or a contributor, according to one exemplary embodiment.

According to an exemplary embodiment, the method can further include: providing, by the at least one processor, an advertisement opportunity for displaying at least one advertisement of a product or service of the user, donor, contributor, initiator, or beneficiary, wherein, the advertisement opportunity is related to the funds, a donation, or the at least one created online fundraising campaign, or wherein at least one or more of: a value of the funds, the donation, or the at least one created online fundraising campaign determine, by the at least one processor, at least one or more of: an advertisement location, an advertisement size, or an advertisement scope, according to one exemplary embodiment.

According to an exemplary embodiment, the method can include where the providing, by the at least one processor, the advertisement includes at least one or more of: providing, by the at least one processor, an Internet hyperlink to another website, providing, by the at least one processor, a descriptive text advertisement, providing, by the at least one processor, a graphical advertisement, providing, by the at least one processor, a video advertisement, or providing, by the at least one processor, an audio advertisement, according to one exemplary embodiment.

According to an exemplary embodiment, the method can further include: publishing, by the at least one processor, a profile of a user including at least one or more of: a name, a location, a photo, cumulative giving, recent giving, or comments, according to one exemplary embodiment.

According to an exemplary embodiment, the method can further include: sending, by the at least one processor, from at least one or more of: browsing public, donor, contributor, beneficiary, user, or initiator, wherein the sending, by the at least one processor, includes at least one or more of: sending, by the at least one processor, a hyperlink to notify others of the at least one or more of the created online fundraising campaign, or book marking, by the at least one processor, a particular one of the at least one or more of the created online fundraising campaigns for future viewing, according to one exemplary embodiment.

According to an exemplary embodiment, the method can include where the conducting, by the at least one processor, raffles in which at least one or more of: donor, contributor, initiator, beneficiary, browsing public, or user participates, according to one exemplary embodiment.

According to an exemplary embodiment, the method can include where the the displaying the terms and conditions comprise at least one or more of: selecting, by the at least one processor, a duration of the at least one or more of the created online fundraising campaign based on at least one or more of reaching, by the at least one processor, at least one or more of: a threshold amount of funds raised, a fixed calendar date and time, or expiration of a period of time; selecting, by the at least one processor, a party responsible for any administration fee; selecting, by the at least one processor, a start date and time of the at least one or more of the created online fundraising campaign; or selecting, by the at least one processor, a cancellation term, according to one exemplary embodiment.

According to an exemplary embodiment, the method can further include: choosing, by the at least one processor, a list of potential beneficiaries by at least one or more of: the public, the contributors, the online fundraising service provider, or the donors, according to one exemplary embodiment.

According to an exemplary embodiment, the method can further include at least one or more of: listing, by the at least one processor; or enabling, by the at least one processor, voting on, wherein the listing or the voting on, relates to a plurality of potential beneficiaries by the public, contributors, users, or donors, and the votes comprise at least one or more of: uniformly weighting, by the at least one processor, or weighting, by the at least one processor, by donation or contribution amount paid by the donor, user, or contributor, according to one exemplary embodiment.

According to an exemplary embodiment, the method can further include: determining, by the at least one processor, a list of one or more potential beneficiaries in an auction process, with those seeking to be the beneficiaries bidding on a chance to be listed as the one or more potential beneficiaries, wherein the determining includes: receiving, by the at least one processor, bids of potential beneficiaries; conducting, by the at least one processor, an auction of the bids; awarding, by the at least one processor, the one or more of the potential beneficiaries as one or more auction winner; and creating, by the at least one processor, an online fundraising campaign for the one or more auction winner, according to one exemplary embodiment.

According to an exemplary embodiment, the method can further include: providing, by the at least one processor, an affiliate program wherein other users provide referrals can include at least one or more of: promoting, by the at least one processor, or referring, by the at least one processor, new users to the online fundraising service provider via the referrals, the referrals can include at least one or more of: a website, a blog, a social network, an email list, or another platform, in which the referrals are provided by the providing, by the at least one processor, can include at least one or more of: tracking, by the at least one processor, crediting, by the at least one processor, to the referee, or compensating, by the at least one processor, via at least one or more of a flat rate, a commission of fees generated by the referred users, or a bonus, the compensating, by the at least one processor, based on compensating on volume of at least one or more of: referrals, fees generated, by donation, funds, or contribution volume, or cumulative contribution amounts generated, according to one exemplary embodiment.

According to an exemplary embodiment, the method can include where the a particular one of the at least one or more of the created online fundraising campaign publicized or promoted includes at least one or more of: at least one campaign captured and stored electronically online, by the at least one computer processor, specified by the promoter can include at least one or more of: browsing public, registered user, user, contributor, beneficiary, donor, or initiator; or at least one campaign specified by the online fundraising service provider through the provision of distributable instruction code can include at least one or more of: a graphic, a button, a text link, a “widget”, or a “mashup”, wherein the distributable instruction code is installed on, at least one or more of: another website, blog, or mobile device; at least one campaign displaying at least one or more of: an individual, a sequential series, or a randomly generated one of at least one or more of the established online fundraising campaign, or at least one campaign identified or qualified in some fashion by the online fundraising service provider for third party distribution, wherein display options and criteria are selected or specified by the promoter, according to one exemplary embodiment.

According to an exemplary embodiment, the method can include where the: providing, by the at least one computer processor, display of at least one posting on the at least one online electronic social network wall can include at least one or more of: providing, by the at least one computer processor, display of for each of the at least one created online fundraising campaign, a list of the postings; providing, by the at least one computer processor, display of an electronic image of a poster; providing, by the at least one computer processor, display of an electronic message of a poster; or providing, by the at least one computer processor, display of an informational link associated with at least one or more of the created online fundraising campaign, according to one exemplary embodiment.

According to an exemplary embodiment, the method can include where the each of the online electronic social network wall post includes at least one or more of: an electronic message of support from the user, donor or contributor for the beneficiary or the at least one or more of the created online fundraising campaign; a comment of the user, donor or contributor; an indication of at least one or more of: funds raised, or donor activity, of the user, donor or contributor; a photo of the user, donor or contributor; or a link to a profile page of the user, donor or contributor, according to one exemplary embodiment.

According to an exemplary embodiment, the method can include: publishing, by the at least one computer processor, an online profile of a user can include at least one or more of: a name of the user, a location of the user, a photo of the user, an indication of cumulative funds raised or funds contributed of the user, an indication of recent funds raised or funds contributed, or at least one user comment of the user, according to one exemplary embodiment.

According to an exemplary embodiment, a computer-implemented online electronic fundraising service provider system, of an online fundraising service provider, configured to electronically create, electronically manage and electronically host a plurality of online electronic fundraising campaigns and of providing for rapid distribution of funds, and transaction state, by electronic initiation of electronic distribution of funds raised, the computer-implemented online electronic computer fundraising service provider system can include an online electronic fundraising service provider social networking computing system can include at least one electronic computer processor, and at least one electronic computer memory coupled to the at least one electronic computer processor, wherein the online electronic fundraising service provider social networking computing system is configured to be coupled by at least one electronic communications network to a plurality of online electronic social networking system computing devices can include: at least one or more of: an electronic mobile device, an electronic interactive television device, a wired electronic communications device, a wireless electronic communications device, an electronic social networking system web-browser based program, an electronic handheld device, an electronic telephony device, an electronic streaming technology device; an electronic telephone; an electronic personal digital assistant (PDA); an electronic personal computer (PC); an electronic handheld PC; an electronic client workstation; an electronic thin client; an electronic thick client; an electronic proxy server; an electronic network communication server; an electronic remote access device; an electronic client computer; or an electronic server computer; and coupled to at least one communications network; and wherein the online electronic fundraising service provider social networking computing system is in network communication over the at least one communications network with at least one or more of: the plurality of online electronic social networking system computing devices, an initiator computing device, a beneficiary computing device, or at least one donor computing device, or contributor computing device via at least one or more of: an electronic mobile device, an electronic interactive television device, an electronic wired communications device, an electronic wireless communications device, an electronic social networking system web-browser based program, an electronic handheld social networking system computing device, an electronic telephony device, or an electronic streaming technology device; wherein each of the plurality of online electronic social networking system computing devices coupled to the online electronic fundraising service provider social networking computing system of the computer-implemented online electronic fundraising service provider system includes: at least one computer processor; and at least one memory coupled to the at least one computer processor, wherein the computer-implemented online electronic fundraising service provider system is configured to electronically allow creation of, by the at least one electronic computer processor, a plurality of online electronic fundraising campaigns, hosting of the plurality of online electronic fundraising campaigns, and managing initiating and transaction state of electronic disbursement of funds of the plurality of the online electronic fundraising campaigns, the computer-implemented online electronic fundraising service provider system can include: wherein the at least one computer processor of the online electronic fundraising service provider social networking computing system is configured to: electronically receive, by the at least one electronic computer processor, an electronic request to electronically create at least one online electronic fundraising campaign, from an initiator computing device of an initiator, wherein the initiator computing device includes at least one or more of: a) an individual initiator computing device other than a non-profit entity, b) a group initiator computing device other than a non-profit entity, or c) a for-profit business initiator computing device, for benefit of beneficiary having a beneficiary computing device, wherein the beneficiary computing device includes at least one or more of: a) an individual beneficiary computing device not a non-profit entity, b) a group beneficiary computing device not a non-profit entity, or c) a for-profit beneficiary computing device, upon receipt of the request to electronically create the at least one online electronic fundraising campaign electronically create, by the at least one electronic computer processor, the at least one electronic online electronic fundraising campaign; and electronically create, by the at least one electronic computer processor, at least one online electronic fundraising campaign page for the at least one electronically created online electronic fundraising campaign, in response to the received request; electronically enable, by the at least one electronic computer processor, at least one or more of the initiator computing device or the beneficiary computing device to receive data indicative of a plurality of funds raised from a plurality of users computing devices of the at least one electronically created online electronic fundraising campaign via each of the plurality of online electronic social networking system computing devices coupled to the online electronic fundraising service provider social networking computing system via the communications network; electronically create, by the at least one electronic computer processor, an online electronic computer social network wall associated with the at least one electronically created online fundraising campaign, electronically, by the at least one electronic computer processor, receive input of, and display output on a graphical user interface of the online electronic computer social network wall can include at least a portion of the online electronic computer social network wall, of any online electronic computer social network wall posts from any of the plurality of users to the at least one electronically created online electronic fundraising campaign; wherein the online electronic computer social network wall posts comprise at least one or more of: an online electronic computer donor post can include at least one or more of: an online electronic computer social media wall post from a donor computing device to the at least one electronically created online electronic fundraising campaign; a donation from the donor computing device; an online electronic computer social network wall post of an electronic message of support from the donor computing device for the beneficiary computing device; or an online electronic computer social network wall post promoting the at least one electronically created online electronic fundraising campaign; at least one online electronic computer social network wall post from at least one or more of: the beneficiary computing device; the initiator computing device; a registered user computing device; a user computing device; a visitor computing device; a member of the browsing public computing device; or one or more of the donors computing devices an online electronic computer beneficiary post can include at least one or more of: an online electronic computer social network wall post from the beneficiary computing device; an online electronic computer social network wall post promoting the at least one electronically created online fundraising campaign; an online electronic computer social network wall post of an electronic message from the beneficiary computing device; or an online electronic computer social network wall post of a thank you from the beneficiary computing device; or an online electronic computer initiator post can include at least one or more of: an online electronic computer social network wall post from the initiator computing device; an online electronic computer social network wall post promoting the at least one electronically created online fundraising campaign; an online electronic computer social network wall post of an electronic message from the initiator computing device; an online electronic computer social network wall post of a thank you from the initiator computing device; or an online electronic computer social network wall post of an electronic message of support from the initiator computing device of the at least one electronically created online fundraising campaign; electronically create, by the at least one electronic computer processor, an online electronic computer displayable scoreboard associated with the at least one electronically created online fundraising campaign, wherein the online electronic computer displayable scoreboard includes: a cumulative value of funds raised from the plurality of users computing devices of one or more of the at least one electronically created online fundraising campaign, wherein the cumulative value is computed by at least one or more of: at least one threshold, a giving total, a frequency, or at least one particular time period can include at least one or more of: a day, a week, a month, a year, or a total time period, electronically enable, by the at least one electronic computer processor, collecting from the initiator computing device or the beneficiary computing device disbursement information of the initiator or beneficiary to electronically receive at least a portion of funds from the plurality of online electronic social networking system computing devices of the at least one electronically created online fundraising campaign via the electronic disbursement process; and electronically initiate, by the at least one electronic computer processor, the electronic disbursement process of the at least a portion of the funds raised from the at least one electronically created online fundraising campaign according to the disbursement information collected from the beneficiary computing device of the beneficiary or initiator computing device of the initiator; wherein the initiation of the electronic disbursement process is performed at least one or more of: electronically, by the at least one electronic computer processor, at least one or more of: as soon as funds are received, in a batch process at a later time, at a periodic time interval, at a time when the donor computing device, the initiator computing device, the beneficiary computing device, payment processor computing device, the computer-implemented online electronic fundraising service provider system, or recipient computing device requests the disbursement, or in a payment disbursement process; or electronically, by the at least one electronic computer processor, by electronic funds transfer (EFT), at least one or more of: as soon as funds are received, in a batch process at a later time, at a periodic time interval, at a time when the donor computing device, initiator computing device, beneficiary computing device, payment processor computing device, the computer-implemented online electronic fundraising service provider system, requests the disbursement, or in a payment disbursement process; electronically receive, by the at least one electronic computer processor, at least one electronic search query from at least one visitor computing device searching at least one listing of at least one or more of the electronically created online fundraising campaign by at least one criterion; and at least one or more of: electronically provide, by the at least one electronic computer processor, at least one electronic tool can include distributable computer instruction code for at least one or more of: browsing public computing device, registered user computing device, user computing device, contributor computing device, beneficiary computing device, donor computing device, or initiator computing device, or electronically provide, by the at least one electronic computer processor, at least one electronic tool to publicize or promote the at least one or more of the created online fundraising campaigns hosted by the computer-implemented online electronic fundraising service provider system, on the at least one graphical user interface can include at least one or more of: at least one website, at least one blog, or at least one mobile device; and wherein the at least one computer processor configured to create, by the at least one electronic computer processor, the online electronic computer displayable scoreboard on the graphical user interface includes: the at least one computer processor configured to display, by the at least one electronic computer processor, at least one or more of: an electronic computer displayable graphic element representative of; or an electronic computer displayable text representation of, the cumulative value of the funds raised, according to one exemplary embodiment.

According to an exemplary embodiment, the system can include: the at least one computer processor configured to create the online electronic computer displayable scoreboard displays on the graphical user interface the cumulative value of the funds raised can include wherein the at least one computer processor is configured to at least one or more of: dynamically calculate the cumulative value of the funds raised; electronically store and display data about at least a portion of donors or contributors providing funds raised; or electronically store and display a total number of donors or contributors providing funds raised, according to one exemplary embodiment.

According to an exemplary embodiment, the system can include: the at least one processor configured to receive and display on the graphical user interface the online social network wall posts includes wherein the at least one processor is configured to at least one or more of: receive at least one comment from at least one donor, user, or contributor; or receive at least one question from at least one potential donor, contributor, user, or browsing public, according to one exemplary embodiment.

According to an exemplary embodiment, the system can include: the beneficiary computing device includes at least one or more of: the initiator computing device; an individual person computing device in financial need other than a non-profit organization; an individual person computing device; a group computing device; a family computing device; a for-profit entity computing device; a business computing device other than a non-profit organization; a corporation computing device other than a non-profit organization; an entity computing device raising money on their own behalf other than a non-profit organization; an entity computing device raising money in the name of a corporation other than a non-profit organization; an entity computing device raising money in the name of a business other than a non-profit organization; or an entity computing device raising money in the name of a group other than a non-profit organization, according to one exemplary embodiment.

According to an exemplary embodiment, a nontransitory computer program product embodied on at least one computer accessible nontransitory storage medium, the computer program product can include computer program logic, which when executed on the at least one computer processor, executes the method noted above, according to one exemplary embodiment.

According to an exemplary embodiment, the method can include where: the online fundraising campaign page includes an individual donation post or an individual contribution post and a cumulative donation or a contribution value is at least one or more of: calculated, updated dynamically and continually, or displayed, as donations or contributions are received, according to one exemplary embodiment.

According to an exemplary embodiment, the method can include where: the electronic disbursement process enables electronically disbursing the at least a portion of the funds raised according to the disbursement information collected from the at least one or more of: the beneficiary computing device or initiator computing device, according to one exemplary embodiment.

According to an exemplary embodiment, the method can include where: the electronic disbursement ensures timely, efficient, and verifiably assured disbursement of funds according to the disbursement information collected from the computing device of at least one or more of: beneficiary or initiator, designated by the donor, contributor or user, according to one exemplary embodiment.

According to an exemplary embodiment, the method can include where at least one or more of: dynamically updating and displaying the cumulative value of funds raised driving increased giving, or dynamically updating display of individual donations or contributions of the electronic social network wall posts encouraging viral giving and building momentum, according to one exemplary embodiment.

According to an exemplary embodiment, the method can include at least one or more of: wherein at least one or more of: the online fundraising campaign page, the online electronic social network wall, the online electronic social network wall posts, or the online electronic computer displayable scoreboard, are on the same webpage, or on a different webpage, or application portion, or combination thereof; or wherein any combination of, or at least a portion of, at least one or more of: the online fundraising campaign page, the online electronic social network wall, the any online electronic social network wall posts, the data indicative of a plurality of funds from a plurality of social networking system computing devices, the online electronic computer displayable scoreboard, the cumulative value of funds raised, or the initiating of electronic disbursement of the at least a portion of funds raised, is configured to be executed on at least one or more of: a same social networking system computing device, or a different social networking system computing device; and wherein any combination of, or a portion of, the at least one or more of: the online fundraising campaign page, the online electronic social network wall, the any online electronic social network wall posts, the data indicative of a plurality of funds from a plurality of social networking system computing devices, the online electronic computer displayable scoreboard, the cumulative value of funds raised, or the initiating of electronic disbursement of the at least a portion of funds raised, is configured to be displayed on at least one or more of: a same application page, a portion of an application page, or a different application page, according to one exemplary embodiment.

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 is a diagram illustrating an exemplary embodiment of an exemplary system for accessing, creating, managing, hosting, and conducting fundraising campaigns in accordance with the systems and methods for fundraising campaigns,

FIG. 2 is a block diagram illustrating one exemplary embodiment of an architecture for an exemplary fundraising management system including relationships of the system layers involved in the implementation of FIG. 1;

FIG. 3 is a block diagram illustrating an exemplary embodiment of a computer system that may be used in conjunction with any of the systems of FIG. 1 and FIG. 2 and the processes of FIG. 4, FIG. 5, and FIG. 6;

FIG. 4 is a flow chart illustrating an exemplary embodiment of a high level process or method of creating, conducting, receiving and disbursing proceeds from a fundraising campaign which may be implemented on the system of FIG. 1;

FIG. 5 is a flow chart illustrating an exemplary embodiment of a more detailed fundraising campaign process which may be implemented on the system of FIG. 1:

FIG. 6 is a flow chart illustrating an exemplary embodiment of a user interaction fundraising campaign process which may be implemented on the system of FIG. 1,

FIG. 7 depicts an exemplary screen shot of an exemplary embodiment of a web-browser-based embodiment of an online electronic fundraising service provider system, according to an exemplary embodiment of the present invention;

FIG. 8 depicts another exemplary screen shot of an exemplary embodiment of the web-browser-based embodiment of the online electronic fundraising service provider system shown in FIG. 7, further showing a specific exemplary beneficiary's online fundraising campaign page, according to an exemplary embodiment of the present invention;

FIG. 9 depicts an exemplary screen shot of an exemplary embodiment of a list of exemplary donor posts on an exemplary social networking donor wall with exemplary fund raising donations and exemplary donor text and/or image posts, of the exemplary web-browser-based embodiment of the online electronic fundraising service provider system shown in FIGS. 7 and 8, according to an exemplary embodiment of the present invention,

FIG. 10 depicts an exemplary flow diagram, according to one exemplary embodiment of an exemplary block chain electronic funds distribution process, according to one exemplary embodiment;

FIG. 11 depicts an exemplary block diagram illustrating an exemplary block chain network with exemplary participants as could be included in an exemplary embodiment of the present invention; and

FIG. 12 depicts an exemplary screen shot (from a television news report on the innovative RealityCharity.com website) of an exemplary embodiment of the web-browser-based embodiment of the online electronic fundraising service provider system shown in FIG. 7, further showing a partial but far from exhaustive list of the numerous types of online fundraising campaign categories and causes conceived of, supported, implemented, and hosted by the system, according to an exemplary embodiment of the present invention.

### DETAILED DESCRIPTION OF VARIOUS EXEMPLARY EMBODIMENTS OF THE DISCLOSURE

A preferred exemplary embodiment of the invention is discussed in detail below. While specific exemplary embodiments are discussed, it should be understood that this is done for illustration purposes only. A person skilled in the relevant art will recognize that other components and configurations may be used without parting from the spirit and scope of the invention.

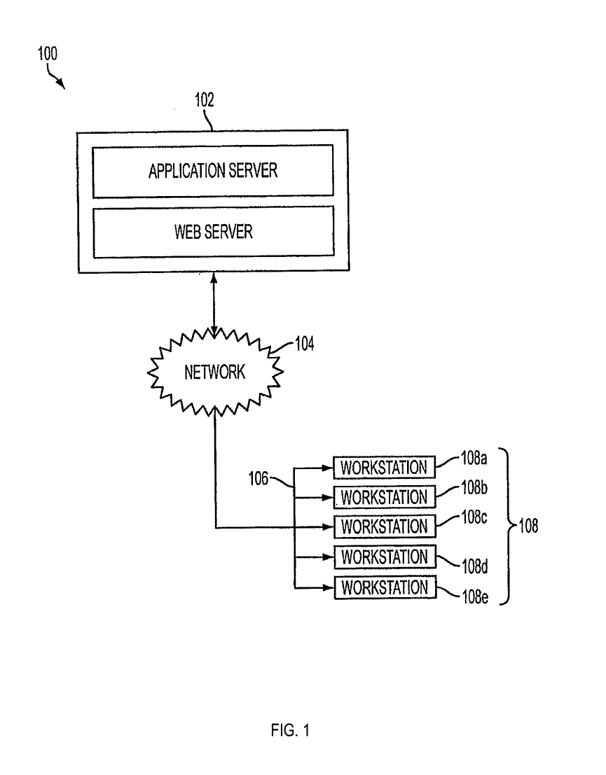

FIG. 1 depicts a block diagram 100 including an exemplary system environment according to an exemplary embodiment of the present invention Diagram 100 may include, in an exemplary embodiment, a fundraising campaign system service provider 102 which may be coupled to a network 104. Network 104, in an exemplary embodiment, may include the global Internet. In an exemplary embodiment, the system environment may be a client-server system environment. In another exemplary embodiment, the system may be an application service provider (ASP) Network 104 may in turn be coupled, in an exemplary embodiment to one or more workstations 106 of users 108. A user 108 a may be also referred to as an initiator A user 108 b may be referred to as a beneficiary. User 108 c may be referred to as a donor 108 c A user 108 d may be referred to as a registered user. A user 108 e may be referred to as a visitor. Various other users, such as, e.g., but not limited to, the browsing public, may also access fundraising campaigns hosted or managed on the fundraising campaign system service provider server 102.

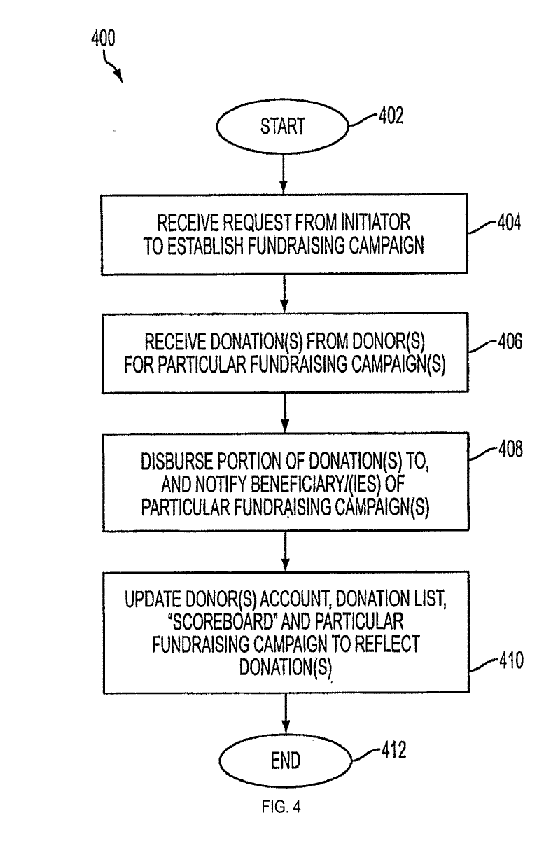

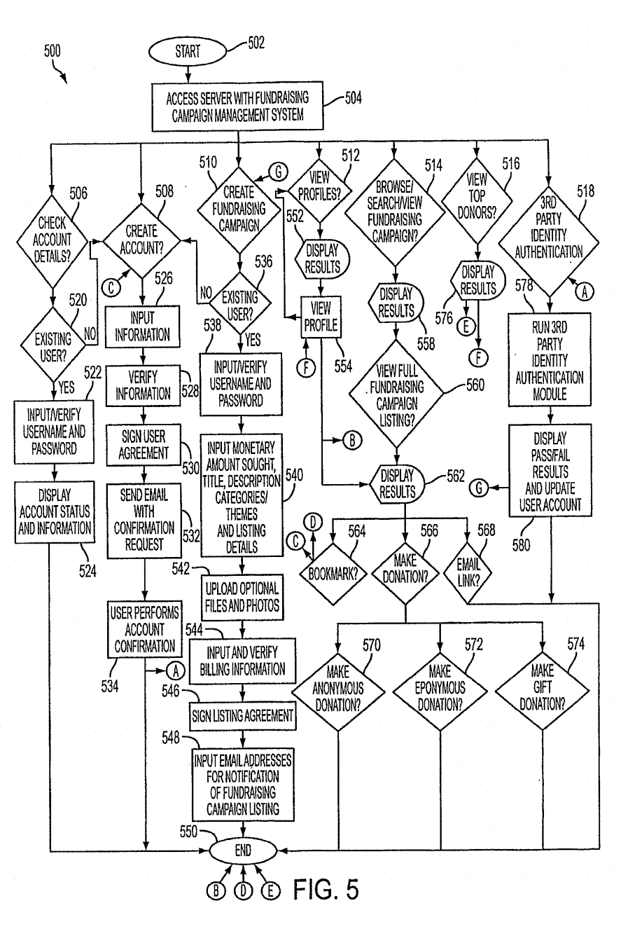

An initiator 108 a may create a fundraising campaign using the fundraising campaign system service provider 102. In an exemplary embodiment, the initiator 108 a—may create a fundraising campaign using a method as discussed further below with reference to FIGS. 4 and 5. In one exemplary embodiment, the initiator 108 a may pay an initiation fee to the fundraising campaign service provider 102. In another exemplary embodiment, the initiator 108 a may pay a fundraising campaign listing fee for a particular period. In another exemplary embodiment, the initiator 108 a may pay a fundraising campaign completion fee. In another exemplary embodiment, the user 108 a may create a fundraising campaign using the fundraising campaign system service provider 102, but the fundraising campaign may not begin or be publicized until the fundraising campaign system service provider 102 approves of the fundraising campaign. In another exemplary embodiment, the initiator 108 a may select from a plurality of monetary currencies in which to conduct the fundraising campaign. In another exemplary embodiment, initiator 108 a may receive preferential placement on a website for a fundraising campaign based on, e.g., but not limited to, a particular fundraising campaign initiation fee and/or a listing fee. In another exemplary embodiment, beneficiary 108 b may receive preferential placement on a website for a fundraising campaign based on, e.g., but not limited to, a particular fundraising campaign initiation fee and/or a listing fee. In one exemplary embodiment, the initiator 108 a may also be the beneficiary 108 b. In another exemplary embodiment, the initiator 108 a may also be the fundraising campaign service provider 102. In another exemplary embodiment, initiator 108 a may receive preferential placement on, e.g., but not limited to, a website based on a commission level and/or auction bid level In another exemplary embodiment, initiator 108 a may receive preferential placement on a website based on, e.g., but not limited to, an activity level and/or fundraising campaign popularity.

In another exemplary embodiment, initiator 108 a may send email notifications or direct links to others to draw their attention to the particular fundraising campaign.

A beneficiary 108 h may benefit from the donations received by a fundraising campaign conducted by the fundraising campaign service provider 102 In one exemplary embodiment, the initiator 108 a may be the beneficiary 108 b In one exemplary embodiment, the beneficiary 108 b may be selected by the initiator 108 a. In another exemplary embodiment, the beneficiary 108 b may not be pre-determined. In another exemplary embodiment, the beneficiary 108 b may be determined by performing a task. In another exemplary embodiment, the beneficiary 108 b may be determined by paying a payment. In another exemplary embodiment, the beneficiary 108 b may be determined by placing a bid at a threshold amount. In another exemplary embodiment, the beneficiary 108 b may be determined by being selected from a list of potential beneficiaries who each may pay a price to appear on the list. In another exemplary embodiment, the beneficiary 108 b may be determined by being selected from a list of potential beneficiaries who were randomly selected. In another exemplary embodiment, the beneficiary 108 b may pay, e.g., but not limited to, a fundraising campaign completion fee which may be a flat rate or an amount related to the total money raised in the fundraising campaign. In another exemplary embodiment, there may be a plurality of beneficiaries. In another exemplary embodiment, beneficiary 108 b may be selected or voted on from a list of potential beneficiaries by donors 108 c, registered users 108 d, and/or visitors 108 e. In another exemplary embodiment, beneficiary 108 b may provide information and/or documentation as supporting evidence of the beneficiary's need for the funds In another exemplary embodiment, beneficiary 108 b may undergo a third-party identity verification and/or authentication process, whose outcome may be known (or may not be known) to the browsing public, donors 108 c, registered users 108 d, and/or visitors 108 e. In another exemplary embodiment, beneficiary 108 b may be determined by conducting a drawing. In another exemplary embodiment, people seeking to be beneficiary 108 b may bid in an auction process for the opportunity to be in a list of one or more potential beneficiaries. In another exemplary embodiment, beneficiary 108 b may be selected, and/or may be voted on, by the public. In another exemplary embodiment, beneficiary 108 b may send a thank you note and/or email to donor 108 c.

A donor 108 c may pay money to the fundraising campaign service provider 102 to donate to a particular fundraising campaign. In one exemplary embodiment, donor 108 c may participate in a foreign currency fundraising campaign by converting the native currency of donor 108 c into the fundraising campaign currency, through the fundraising campaign system service provider 102, via an exchange rate. In another exemplary embodiment, a donor 108 c may become a beneficiary 108 b. In another exemplary embodiment, donors 108 c may choose a list of potential beneficiaries. In another exemplary embodiment, donors 108 c may vote on a plurality of potential beneficiaries, and these votes may be weighted including, e.g., but not limited to, being uniformly weighted and/or weighted by the donation amount paid by donors 108 c.

According to an exemplary embodiment, the fundraising campaign service provider 102 may manage the creation, and/or conducting of various fundraising campaigns created by initiators 108 a. In one exemplary embodiment, the initiator 108 a may also be the fundraising campaign service provider 102. In another exemplary embodiment, a fundraising campaign may immediately appear to the browsing public upon creation and submission by initiator 108 a. In another exemplary embodiment, the fundraising campaign service provider 102 may review, authorize, and/or validate a fundraising campaign from an initiator 108 a prior to the campaign appearing to the browsing public.

A registered user 108 d may have the campaign register an account with the fundraising campaign service provider, and may become an initiator 108 a, beneficiary 108 b, and/or donor 108 c.

A visitor 108 e may be a member of the browsing public and may or may not become an initiator 108 a, beneficiary 108 b, donor 108 c, or registered user 108 d. In one exemplary embodiment, visitors may choose or vote on a list of potential beneficiaries 108 b. In one exemplary embodiment, visitor 108 e may view a fundraising campaign in progress and may vote for the visitor's choice of beneficiary 108 b from a list of a plurality of potential beneficiaries. In another exemplary embodiment, visitor 108 e may perform browse or search queries to list fundraising campaigns by at least one criterion via the fundraising campaign service provider 102. In an exemplary embodiment, fundraising campaigns may be searched by, e.g., but not limited to, category, initiator location, region, religion, race, and/or by any specific keyword(s). In another exemplary embodiment, visitor 108 e may send an email link to notify others of a particular fundraising campaign. In another exemplary embodiment, visitor 108 e may become an initiator 108 a, a beneficiary 108 b, donor 108 c, and/or a registered user 108 d.

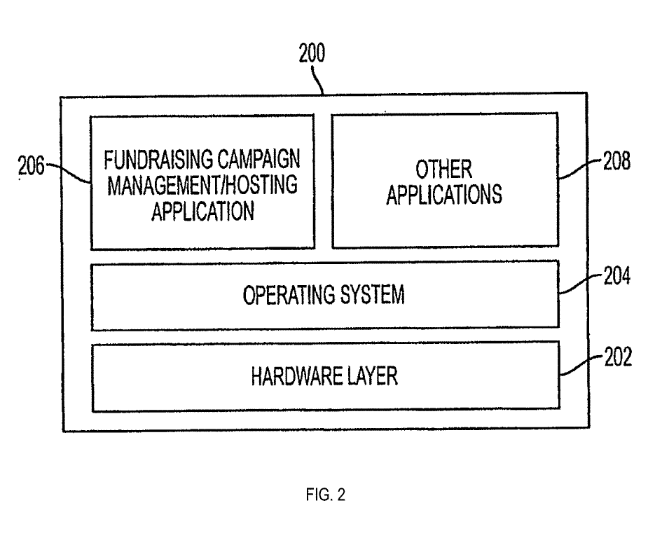

FIG. 2 is a block diagram 200 illustrating an exemplary embodiment of an architecture for an exemplary fundraising campaign management system including relationships of exemplary system architecture layers involved in an exemplary implementation of fundraising campaign service provider system 102 of FIG. 1 Diagram 200 may include, in an exemplary embodiment, a hardware (HW) layer 202, an operating system (OS) 204, and one or more applications which may be application software programs such as, e.g., but not limited to, a fundraising campaign management/hosting application 206 and/or other applications 208.

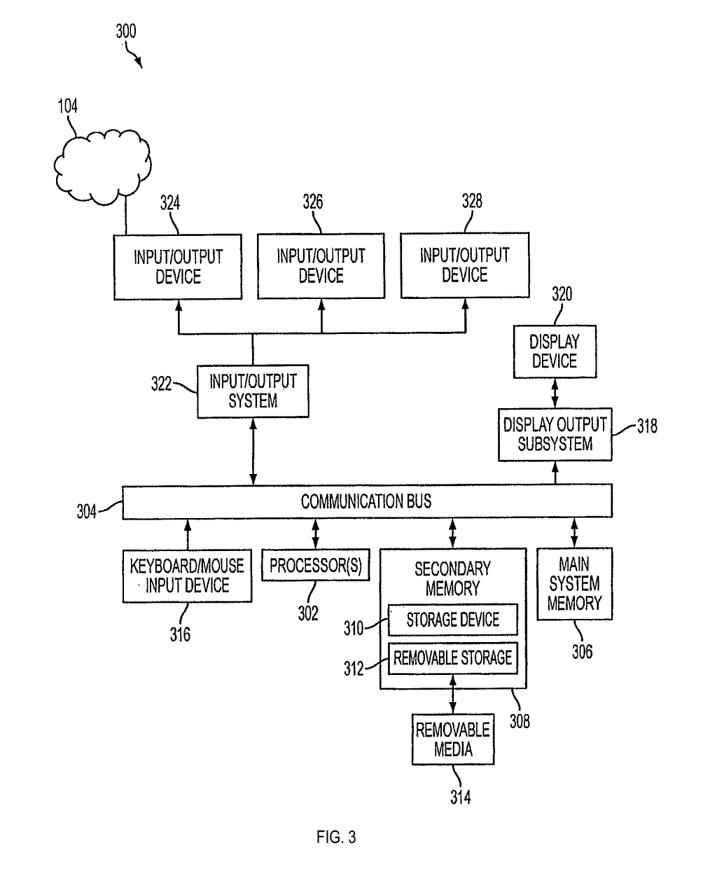

FIG. 3 depicts an exemplary embodiment of a block diagram 300 illustrating an exemplary embodiment of a computer system 102, 106 that may be used in conjunction with any of the systems depicted in diagram 100 of FIG. 1 or hardware layer 202 of diagram 200 of FIG. 2. Further, computer system 102, 106 of block diagram 300 may be used to execute any of various methods and/or processes such as, e.g., but not limited to, those discussed below with reference to FIGS. 4, 5, and 6. FIG. 3 depicts an exemplary embodiment of a computer system 102, 106 that may be used in computing devices such as, e.g., but not limited to, client 106 and/or server 102 computing devices according to an exemplary embodiment of the present invention. FIG. 3 depicts an exemplary embodiment of a computer system that may be used as client device 106, or a server device 102, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 300 is shown in FIG. 3, depicting an exemplary embodiment of a block diagram of an exemplary computer system useful for implementing the present invention. Specifically, FIG. 3 illustrates an example computer 300, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HI-PUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 300 is shown in FIG. 3. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 3.

The computer system 300 may include one or more processors, such as, e.g., but not limited to, processor(s) 302. The processor(s) 302 may be coupled or connected to a communication infrastructure 304 (e.g., but not limited to, a communications bus, a backplane, a mother board, a cross-over bar, or network, etc.) Various exemplary software embodiments may be described in terms of this exemplary computer system. After reading this description, it will become apparent to a person skilled in the relevant art(s) how to implement the invention using other computer systems and/or architectures.

Computer system 300 may include a display interface 318 that may forward, e.g, but not limited to, graphics, text, and other data, etc., from the communication infrastructure 304 (or from a frame buffer, etc. not shown) for display on the display unit 320

The computer system 300 may also include, e.g., but may not be limited to, a main memory 306, which may include, e.g., but not limited to, random access memory (RAM), and/or a secondary memory 308, etc. The secondary memory 308 may include, for example. (but not limited to) a storage device 310 such as, e.g., but not limited to, a hard disk drive and/or a removable storage drive 312, representing, e.g., but not limited to, a floppy diskette drive, a magnetic tape drive, an optical disk drive, a compact disk (CD-ROM) device, a magneto-optical (MO) drive, a digital versatile disk (DVD) device, etc The removable storage drive 312 may, e.g., but not limited to, access, read from and/or write to a removable storage unit 314 in a well known manner Removable storage media unit 314, may also be called a program storage device or a computer program product, and may represent, e.g., but not limited to, a floppy disk, magnetic tape, optical disk, CD-ROM disk, a MO media, a DVD disk, etc. which may be accessed, read from, and/or written to by removable storage drive 312. As will be appreciated, the removable storage unit 314 may include, e.g., but not limited to, a computer usable storage medium having stored therein computer software and/or data.

In alternative exemplary embodiments, secondary memory 308 may include other similar devices for allowing computer programs or other instructions to be loaded into computer system 300. Such devices may include, for example, a removable storage unit 314 and a storage subsystem interface adapter (not shown.) Examples of such may include a program cartridge and cartridge interface (such as, e.g., but not limited to, those found in video game devices), a removable memory chip (such as, e.g, but not limited to, an erasable programmable read only memory (EPROM), or programmable read only memory (PROM) and associated socket, and other removable storage units 314 and interfaces, which may allow software and data to be transferred from the removable storage unit 314 to computer system 300

Computer 300 may also include, e.g., but not limited to, an input device 316 such as, e.g., (but not limited to) a mouse or other pointing device such as a digitizer, and/or a keyboard or other data entry device (not separately labeled).

Computer 300 may also include, e.g, but not limited to, output devices 320, such as, e.g, (but not limited to) display, and output subsystem display interface 318.

Computer 300 may also include, e.g., but not limited to, input/output (IOC) system 322 such as, e.g., (but not limited to) a communications interface, a cable and communications path, (not separately shown) etc. as well as I/O devices 324, 326, 328, for example. These devices 324, 326, 328, may include, e.g., but not limited to, a network interface card, and modems (not separately labeled). The communications interface may allow software and data to be, e.g., transferred between computer system 300 and external devices over a network 104, as shown. Examples of the communications interface may include, e.g., but may not be limited to, a modem, a network interface (such as, e.g., an Ethernet card), a communications port, a Personal Computer Memory Card International Association (PCMCIA) or PC-Card slot and card, etc. Software and data transferred via communications interface may be in the form of signals 330 (not shown) which may be electronic, electromagnetic, optical or other signals capable of being received by communications interface. These signals 330 may be provided to communications interface via, e.g., but not limited to, a communications path (e.g., but not limited to, a channel). This channel may carry signals, which may include, e.g, but not limited to, propagated signals, and may be implemented using, e.g., but not limited to, wire or cable, fiber optics, a telephone line, a cellular link, an radio frequency (RF) link and other communications channels, etc

In this document, the terms “computer program medium” and “computer readable medium” may be used to generally refer to media such as, e.g., but not limited to removable storage drive 314, a hard disk installed in storage device 310, and signals 330, etc. These computer program products may provide software to computer system 300. The invention may be directed to such computer program products.

References to “one embodiment.” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose ‘device’ selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media, optical storage media, flash memory devices, electrical, optical, acoustical or other form of propagated signals (e.g., carrier waves, infrared signals, digital signals, etc.), and others.

Computer programs (also called computer control logic), may include object oriented computer programs, and may be stored in main memory 306 and/or the secondary memory 308 and/or removable storage media units 314, also called computer program products. Such computer programs, when executed, may enable the computer system 300 to perform the features of the present invention as discussed herein In particular, the computer programs, when executed, may enable the processor 302 to provide a method to resolve conflicts during data synchronization according to an exemplary embodiment of the present invention. Accordingly, such computer programs may represent controllers of the computer system 300.

In another exemplary embodiment, the invention may be directed to a computer program product comprising a computer readable medium having control logic (computer software) stored therein. The control logic, when executed by the processor 302, may cause the processor 302 to perform the functions of the invention as described herein. In another exemplary embodiment where the invention may be implemented using software, the software may be stored in a computer program product and loaded into computer system 300 using, e.g, but not limited to, removable storage drive 312, storage device 310 or communications interface, etc. The control logic (software), when executed by the processor 302, may cause the processor 302 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium May include read only memory (ROM), random access memory (RAM); magnetic disk storage media; optical storage media; flash memory devices, electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G, nG wireless, Bluetooth, Infrared Data Association (IrDA), shared wireless access protocol (SWAP), “wireless fidelity” (Wi-Fi), W IMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE; 802.11g-2003, etc.), etc.

An exemplary special purpose online fundraising campaign service provider system can include computer-implemented method of electronically creating, electronically managing, and electronically hosting a plurality of online electronic fundraising campaigns and of providing for rapid distribution of funds, and transaction state of electronic initiation of electronic distribution of funds raised, coupled via a communications network to a plurality of electronic social networking system computing devices configured as set forth in the claims, and can include various inputs and/or outputs including any of various sensors including, e.g., but not limited to, touch screens, touch sensors, pressure sensors, accelerometers, location sensors, accounting data database collection sensor/gatherers, fundraising service provider datasets, data sensors, blockchain components, encrypted cryptographically protected user information and account user passwords, and/or other private data, distributed ledgers, etc. Specifically, FIG. 3 illustrates an example fundraising service provider computer 300, which in an exemplary embodiment may be, e.g., (but not limited to) a fundraising service provider personal computer (PC) system in one exemplary embodiment, running an operating system such as, e.g., (but not limited to) MICROSOFT® WINDOWS.degree. 10/8.1/8/7/NT/98/2000/XP/CE/ME/VISTA, etc. available from MICROSOFT®.

Corporation of Redmond, Wash., U.S.A. However, the invention may not be limited to these platforms. Instead, the invention may be implemented on any appropriate exemplary fundraising service provider computer system running any appropriate operating system such as, e.g., but not limited to, Mac OSX, a Mach system, UNIX, iOS, OSX+ any variant Debian, Ubuntu, Linux, Android (available from Alphabet, and/or Google), etc., and/or another programming environment such as, e.g., but not limited to, Java, C, C++, C#, Python, Javascript, Ruby on Rails, PHP, LAMP, NDK, HTML, HTML5, XML, ADOBE FLASH, or the like. In one exemplary embodiment, the present invention may be implemented on an exemplary fundraising campaign service provider computer system, including a computer processor, and memory, with instructions stored in the memory configured to be executed on the computer processor, operating as discussed herein. An exemplary fundraising service provider computer system, exemplary fundraising campaign service provider computer 300 may be shown in FIG. 3. Other components of the invention, such as, e.g., (but not limited to) a fundraising campaign service provider computing device, a communications device, mobile phone, a telephony device, a telephone, a personal digital assistant (PDA), a personal computer (PC), a handheld PC, an interactive television (iTV), a digital video recorder (DVD), a tablet computer, an iPad, an iPhone, an Android phone, a Phablet, a mobile device, a smartphone, a wearable device, a network appliance, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 3. Services may be provided on demand using, e.g., but not limited to, an interactive television (iTV), a video on demand system (VOD), and via a digital video recorder (DVR), or other on demand viewing system.

The exemplary fundraising campaign service provider computer system 300 may include one or more processors, such as, e.g., but not limited to, processor(s) 304. The exemplary fundraising campaign service provider processor(s) 304 may be connected and/or coupled to a communication infrastructure 306 (such as, e.g., but not limited to, a communications bus, cross-over bar, or network, etc.). Various exemplary software embodiments may be described in terms of this exemplary fundraising campaign service provider computer system. After reading this description, it may become apparent to a person skilled in the relevant art(s) how to implement the invention using other exemplary fundraising campaign service provider computer systems and/or architectures. According to an exemplary embodiment, the system can include an fundraising campaign service provider and data transformer 334. In an exemplary embodiment, a cryptographic controller can be included, in an exemplary embodiment, and can be used to, e.g., but not limited to, authenticate a user device, and/or provide encryption and/or decryption processing, according to an exemplary embodiment.

Exemplary fundraising campaign service provider computer system 300 may include a display interface 302 that may forward, e.g., but not limited to, graphics, text, and other data, etc., from the communication infrastructure 306 (or from a frame buffer, etc., not shown) for display on the display unit 330, or other output device 340 (such as, e.g., but not limited to, a touchscreen, etc.).

The exemplary fundraising campaign service provider computer system 300 may also include, e.g., but may not be limited to, a main memory 308, random access memory (RAM), and a secondary memory 310, etc. The secondary memory 310 may include, for example, (but not limited to) a hard disk drive 312 and/or a removable storage drive 314, representing a floppy diskette drive, a magnetic tape drive, an optical disk drive, a compact disk drive CD-ROM, etc. The removable storage drive 314 may, e.g., but not limited to, read from and/or write to a removable storage unit 318 in a well known manner. Removable storage unit 318, also called a program storage device or a computer program product, may represent, e.g., but not limited to, a floppy disk, magnetic tape, solid state disc (SSD), SDRAM, Flash, a thumb device, a USB device, optical disk, compact disk, etc. which may be read from and written to by removable storage drive 314. As may be appreciated, the removable storage unit 318 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CDROM) or a digital versatile disk (DVD); a magnetic tape; and/or a memory chip, etc. Communications networking subsystem can be coupled to an electronic network coupled to a data provider, various secure connections allowing electronic receipt of data, and transfer of data to partner systems.

In alternative exemplary embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 322 such as, e.g., but not limited to, SDRAM, Flash, a thumb device, a USB device, and interfaces 320, which may allow software and data to be transferred from the removable storage unit 322 to computer system 300.

Exemplary fundraising campaign service provider computer 300 may also include an input device 316 such as, e.g., (but not limited to) a mouse or other pointing device such as a digitizer, and a keyboard or other data entry device (not shown), or an input sensor device 332, such as, e.g., but not limited to, a touch screen, a pressure sensor, an accelerometer, and/or other sensor device such as, e.g., a pressure sensor, a rangefinder, a compass, a camera, accelerometer, gyro, ultrasonic, biometric, secure authentication system, etc.

Exemplary fundraising campaign service provider computer 300 may also include output devices, such as, e.g., (but not limited to) display 330, and display interface 302, or other output device 340. Exemplary fundraising campaign service provider computer 300 may include input/output (I/O) devices such as, e.g., (but not limited to) sensors, touch sensitive, pressure sensitive input systems, accelerometers, and/or communications interface 324, cable 328 and communications path 326, etc. These communications networking devices may include, e.g., but not limited to, a network interface card, and modems (neither are labeled).

From a data model, which can automate the process of creating an online fundraising campaign the fundraising service provider computer system 354, can process incoming electronic data and can transform the data into online fundraising campaign pages, and/or related social media posts, and can then provide the transformed data, in the form of data indicative of the one or more online fundraising campaigns, posts relating to fundraising posts, cumulative fundraising goals, fundraising amounts, electronic scoreboard, and electronic funds process and disbursement information, and processing to initiate electronic disbursement, and can be provided to an electronic decision support system (DSS) 358, and/or computer database management system (DBMS) 360 (which can be a relational database, and/or can use a graph database, an SQL database, a noSQL database, and/or other social networking and/or graph database, and/or electronic interactive, graphical user interface (GUI) system 362 (not shown). Each of the exemplary DSS 358, DBMS 360 and/or EIGUI system 362, can then, using e.g., but not limited to, a cryptographic processor and/or a crypto chip controller, or the like, can then encrypt the data using electronic encryptor 364, which can make use of one or more cryptographic algorithm electronic logic 366, which can include encryption code, a cryptographic combiner, etc., and may be stored in encrypted form, according to an exemplary embodiment, in a computer database storage facility, from computer database storage device 368, and from there the process can continue with use of the cryptographic algorithm electronic logic 370, and electronic decryptor 372, which can decrypt and/or provide a process for decrypting encrypted data, and/or by providing such data to the DSS 358, the DBMS 360, or the EIGUI 362, if authorized (not shown). By using encryption/decryption, certain algorithms can be used, as described above, including, e.g., but not limited to, AES encryption, RSA, PKI, TLS, FTPS, SFTP, etc. and/or other cryptographic algorithms and/or protocols.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An exemplary fundraising service provider processing can include algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term exemplary fundraising service provider “system” or “processor” “system on a chip” “microcontroller” “multi-core” may refer to any device or portion of a device that processes electronic data from registers and/or memory to transform that electronic data into other electronic data that may be stored in registers and/or memory. An exemplary fundraising service provider “computing platform” may comprise one or more processors.

Embodiments of the present invention may include exemplary fundraising service provider apparatuses for performing the operations herein. An apparatus may be specially constructed for the desired purposes, selectively activated or reconfigured by an exemplary fundraising service provider program stored in the device in coordination with one or more special purpose data sensors.

In yet another exemplary embodiment, the invention may be implemented using a combination of any of, e.g., but not limited to, hardware, firmware and software, etc.

In one or more embodiments, the present embodiments are embodied in machine-executable instructions. The instructions can be used to cause exemplary fundraising service provider processing device, for example a special-purpose exemplary fundraising service provider processor, which is programmed with the exemplary fundraising service provider instructions, to perform the steps of the present invention. Alternatively, the steps of the present invention can be performed by specific exemplary fundraising service provider hardware components that contain hardwired logic for performing the steps, or by any combination of programmed computer components and custom hardware components. For example, the present invention can be provided as a exemplary fundraising service provider computer program product, as outlined above. In this environment, the embodiments can include a machine-readable medium having exemplary fundraising service provider instructions stored on it. The exemplary fundraising service provider can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution.

Exemplary wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of exemplary special purpose index construction wireless devices. This includes 1G-5G according to present paradigms. 1G refers to the first generation wide area wireless (WWAN) communications systems, dated in the 1970s and 1980s. These devices are analog, designed for voice transfer and circuit-switched, and include AMPS, NMT and TACS. 2G refers to second generation communications, dated in the 1990s, characterized as digital, capable of voice and data transfer, and include HSCSD, GSM, CDMA IS-95-A and D-AMPS (TDMA/IS-136). 2.5G refers to the generation of communications between 2G and 3 G. 3G refers to third generation communications systems recently coming into existence, characterized, for example, by data rates of 144 Kbps to over 2 Mbps (high speed), being packet-switched, and permitting multimedia content, including GPRS, 1.times.RTT, EDGE, HDR, W-CDMA. 4G refers to fourth generation and provides an end-to-end IP solution where voice, data and streamed multimedia can be served to users on an “anytime, anywhere” basis at higher data rates than previous generations, and will likely include a fully IP-based and integration of systems and network of networks achieved after convergence of wired and wireless networks, including computer, consumer electronics and communications, for providing 100 Mbit/s and 1 Gbit/s communications, with end-to-end quality of service and high security, including providing services anytime, anywhere, at affordable cost and one billing. 5G refers to fifth generation and provides a complete version to enable the true World Wide Wireless Web (WWWW), i.e., either Semantic Web or Web 3.0, for example. Advanced technologies may include intelligent antenna, radio frequency agileness and flexible modulation are required to optimize ad-hoc wireless networks.

Furthermore, the fundraising service provider processes and processors need not be located at the same physical locations. In other words, each processor can be executed at one or more geographically distant processor, over for example, a LAN or WAN connection. A great range of possibilities for practicing the exemplary special purpose index construction embodiments may be employed, using different networking hardware and software configurations from the ones above mentioned. Although described with reference to an application server and/or a web-based browser-enabled environment, such as, e.g., but not limited to, a JAVA environment, the application could also be implemented in a client server architecture, or as a mobile based app running on iOS or Android, or the like, and can interact with a server of a fundraising service provider via communication network technology. Also, it is important to note that reference to an electronic network component, is not to require only electronic components, but could also integrate with other common networking equipment including, e.g, but not limited to, optical networking equipment, optical fiber, ATM, SONET, etc.

According to one exemplary embodiment, the online fundraising service provider can be integrated with mobile devices which can run an exemplary an example graphical user interface (GUI) of an exemplary smartphone, and/or mobile phone, and/or computer application, and/or tablet application, and/or Phablet application, etc., application can transmit and/or receive data to and/or from an example mobile fundraising application device (MFAD) and/or server, in various embodiments. Various exemplary GUI elements can be provided, including icons and/or buttons, which can be color coded to indicate whether a new online fundraising campaign, a soon to expire online fundraising campaign, or an expired online fundraising campaign, for example, according to an exemplary embodiment. Various exemplary GUI elements can include scroll bars for scrolling through exemplary lists of online fundraising campaigns, and/or lists of donations/funds raised, etc., according to an exemplary embodiment.

FIG. 4 depicts an exemplary embodiment of a flow chart 400 illustrating an exemplary embodiment of a high level process or method of creating, conducting, receiving and disbursing proceeds from a fundraising campaign which may be implemented on the system of FIG. 1. Flow diagram 400 illustrates an exemplary high level process of conducting a fundraising campaign, which may use the exemplary fundraising campaign service provider 102 according to the present invention. Diagram 400 may begin with 402 and may continue immediately with 404.

In 404, a request may be received from an initiator 108 a at the fundraising campaign service provider 102 to establish a new fundraising campaign. As noted above, in an exemplary embodiment, the initiator 108 a may be prompted to input information including, e.g., but not limited to, any of various criterion, parameters, photos, tile attachments, terms and/or conditions associated with the fundraising campaign being established From 404, flow diagram 400 may continue with 406.

In 406, the fundraising campaign service provider 102 may receive a plurality of donations from a plurality of donors 108 c. From 406, flow diagram 400 may continue with 408.

In 408, a portion of proceeds from donations may be disbursed to the beneficiary of a particular fundraising campaign and the beneficiary may be notified of the donation. From 408, flow diagram 400 may continue with 410.

In 410, the fundraising campaign service provider 102 may update the donor 108 c's account, donation list, “scoreboard.” and/or the particular fundraising campaign listing to reflect the donation, and may continue immediately by ending with 412.

FIG. 5 depicts an exemplary embodiment of a flow chart 500 illustrating an exemplary embodiment of a more detailed fundraising campaign process which may be implemented on the system of FIG. 1. Diagram 500 may begin with 502 and may continue immediately with 504.

In 504, a user 108 may access a fundraising campaign service provider 102 server which may be executing the fundraising campaign management system application 206. As shown in FIG. 1, the fundraising campaign service provider system 102 may include, e.g., but not limited to, an application server and/or a web server. From 504, flow diagram 500 may continue with 506.

In 506, the fundraising campaign service provider 102, in an exemplary embodiment, may check account details for the user. From 506, flow diagram 500 may continue with 520.

In 520, the fundraising campaign service provider 102, in an exemplary embodiment, may check whether the user is an existing user. From 520, if the user 108 is determined to be an existing user, then flow diagram 500 may continue with 522, and if the user 108 is not determined to be an existing user, flow diagram 500 may continue with 508.

In 522, the fundraising campaign service provider 102 may prompt the user 108 to provide a username and password, or other authentication, and the user may provide as input the requested information. From 52, the flow diagram 500 may continue with 524.

In 524, the fundraising campaign service provider 102 may display account status and information about the account to the user 108. From 524, flow diagram 500 may continue immediately by ending at 550, in one exemplary embodiment.

In 508, the fundraising campaign service provider 102, in an exemplary embodiment, may create a new account for the user 108. From 508, flow diagram 500 may continue with 526.

In 526, the fundraising campaign service provider 102, may receive information, input by the user 108 used to create the account, in an exemplary embodiment. From 520, flow diagram 500 may continue with 528.

In 528, the fundraising campaign service provider 102 may verify and/or authenticate the information previously input, in an exemplary embodiment. From 528, flow diagram 500 may continue with 530.

In 530, the fundraising campaign service provider 102, may prompt the user 108 to provide authentication, or to provide agreement to the terms of the user agreement, providing an electronic signature to sign the user agreement, for example, in an exemplary embodiment. From 530, flow diagram 500 may continue with 532.

In 532, the fundraising campaign service provider 102, in an exemplary embodiment, may send an email with a confirmation request. From 532, flow diagram 500 may continue with 534.

In 534, the fundraising campaign service provider 102 may receive from the user 108, an account confirmation from the user, in an exemplary embodiment. From 534, flow diagram 500 may continue with 518, in one exemplary embodiment, or may continue immediately by ending at 550, in another exemplary embodiment.

In 510, the fundraising campaign service provider 102, in an exemplary embodiment, may allow an initiator 108 a to create a fundraising campaign. From 510, flow diagram 500 may continue with 536

In 536, the fundraising campaign service provider 102 may determine whether the user 108 is an existing user, and if so, flow diagram 500 may continue with 538, and if not, then flow diagram 500 may continue with 508, in an exemplary embodiment.

In 538, the fundraising campaign service provider 102, in an exemplary embodiment, may prompt the user 108 to input/verify the user's username and password. From 538, flow diagram 500 may continue with 540.

In 540, the fundraising campaign service provider 102, may receive from the initiator 108 a a fundraising campaign primary and/or secondary category, amount sought, a title, a description, and/or listing details for the fundraising campaign, in an exemplary embodiment. From 540, flow diagram 500 may continue with 542.

In 542, the fundraising campaign service provider 102, may receive from the initiator 108 a an upload of files, and/or photos, and/or other information related to the fundraising campaign, i.e. but not limited to, documentary evidence of initiator 108 a's financial need. From 542, flow diagram 500 may continue with 544.

In 544, the fundraising campaign service provider 102, may receive, verify, and/or process from the initiator 108 a any billing information associated with the fundraising campaign listing.

From 544, flow diagram 500 may continue with 546.

In 546, the fundraising campaign service provider 102, may receive from the initiator 108 a an acknowledgement of acceptance of the fundraising campaign listing agreement, such as, e.g., but not limited to, by entry of an electronic signature, or click through acknowledgement or confirmation of another type. From 546, flow diagram 500 may continue with 548.

In 548, the fundraising campaign service provider 102, may receive from the initiator 108 a a list of email addresses to which a notification of the fundraising campaign may be sent. From 548, flow diagram 500 may continue with 550.

In 512, the fundraising campaign service provider 102, may allow a user 108 to access including, e.g., but not limited to, browsing, searching, and/or viewing, based on a variety of input parameters, profiles of registered users of the fundraising campaign service provider, who may have elected to publish a public profile: From 512, flow diagram 500 may continue with 552.

In 552, the fundraising campaign service provider 102, may display results of the operations of 512 in response to input from the user 108. From 552, flow diagram 500 may continue with 554

In 554, the fundraising campaign service provider 102, may display detailed profile information on the selected user, such as, but not limited to, photographs, demographic information, and/or recent donation information which may include, e.g., but not limited to, links to view and/or donate to the respective fundraising campaigns contributed to, in an exemplary embodiment. In one exemplary embodiment, flow diagram 500 may continue with 562.

Otherwise, flow diagram 500 may continue with step 512, according to another exemplary embodiment, or may end with 550 in another exemplary embodiment

In 514, the fundraising campaign service provider 102, may allow a user 108 to access including, e.g., but not limited to, browsing, searching, and/or viewing, fundraising campaign listings based on a variety of criteria. From 514, flow diagram 500 may continue with 558.

In 558, the fundraising campaign service provider 102, may display results of the operations of 514 in response to input from the user 108. From 558, flow diagram 500 may continue with 560

In 560, the fundraising campaign service provider 102, may determine whether the user 108 wishes to view more detailed information pertaining to a specific fundraising campaign listing, and if so, then from 560, flow diagram 500 may continue with 562.

Otherwise, flow diagram 500 may continue with step 514, according to one exemplary embodiment

in 562, the fundraising campaign service provider 102, may display the specific fundraising campaign listing, in an exemplary embodiment. From 562, flow diagram 500 may prompt the user with steps 564, 566, and/or 568.

In 564, the fundraising campaign service provider 102, may receive from the user 108 a bookmark selection. From 564, flow diagram 500 may continue by book marking the fundraising campaign if the user is already logged into his account, and may end with 550. In another exemplary embodiment, if the user is not logged in, the fundraising campaign service provider may prompt user 108 to log in. If unregistered, the flow diagram may continue with 508, in one exemplary embodiment

In 568, the fundraising campaign service provider 102, may receive from the user 108 a request to email a link to the particular fundraising campaign to another person or persons. From 568, flow diagram 500 may continue by emailing the link, and may end with 550.

In 566, the fundraising campaign service provider 102, may receive from the user 108 a request to make a donation to the particular fundraising campaign. In one exemplary embodiment, the fundraising campaign service provider 102 may require the user to login to his account prior to making a donation, and in the case of an unregistered user, may proceed with 508. In an exemplary embodiment, a potential donor may be prompted with steps 570, 572, and/or 574.

In 570, the fundraising campaign service provider 102 may receive from the user 108 a request to make an anonymous donation to beneficiary 108 b as referenced in the particular fundraising campaign. From 570, flow diagram 500 may continue by processing an anonymous donation for the benefit of beneficiary 108 b as referenced in the particular fundraising campaign on behalf of donor 108 c, and/or may end with 550.

In 572, the fundraising campaign service provider 102 may receive from the user 108 a request to make an eponymous donation—that is, on behalf of himself—to beneficiary 108 b as listed in the particular fundraising campaign The fundraising campaign service provider 102 may prompt the donor 108 c to choose how much personal and/or donation information to forward to the beneficiary 108 b and to publicize. From 572, flow diagram 500 may continue by fundraising campaign service provider 102 processing the donation for the benefit of beneficiary 108 b as referenced in the particular fundraising campaign on behalf of donor 108 c, and may end with 550.

In 574, the fundraising campaign service provider 102 may receive from the user 108 a request to make a gift donation—that is, on behalf of someone else—to beneficiary 108 b as listed in the particular fundraising campaign. The fundraising campaign service provider 102 may prompt the donor 108 c to input information on the third party in whose name the donation may be made From 574, flow diagram 500 may continue by fundraising campaign service provider 102 processing the donation for the benefit of beneficiary 108 b as referenced in the particular fundraising campaign in the name of a third party, and may send a charity gift card via electronic mail, postal mail, mobile message, and/or other delivery method to notify the third party that a donation was made in their name, and may end with 550.

In 516, the fundraising campaign service provider 102, may allow a user 108 to access including, e.g., but not limited to, browsing, searching, and/or viewing top donors on a variety of criteria. From 516, flow diagram 500 may continue with 576.

In 576, the fundraising campaign service provider 102, may display results of the operations of 516 in response to input from the user 108, in an exemplary embodiment In one exemplary embodiment, from 576, flow diagram 500 may continue with 554 if the user wishes to view a profile of a particular donor, or may end with 550, in another exemplary embodiment.

In 518, the fundraising campaign service provider 102, may allow a user 108 to undergo a third party identity verification and authentication process, with a successful result potentially increasing credibility and trust with other users and potential donors. From 518, flow diagram 500 may continue with 578, in one exemplary embodiment.

In 578, the third party identity verification and authentication module may be executed to perform this process. From 578, flow diagram may continue with 580.

In 580, the user 108 may be informed of their pass/fail results of the third party identity verification and authentication process, and their account may be updated to reflect these results.

In one exemplary embodiment, flow diagram 500 may continue with 510 if the newly authenticated user wishes to create a fundraising campaign, or may end with 550, in another exemplary embodiment.

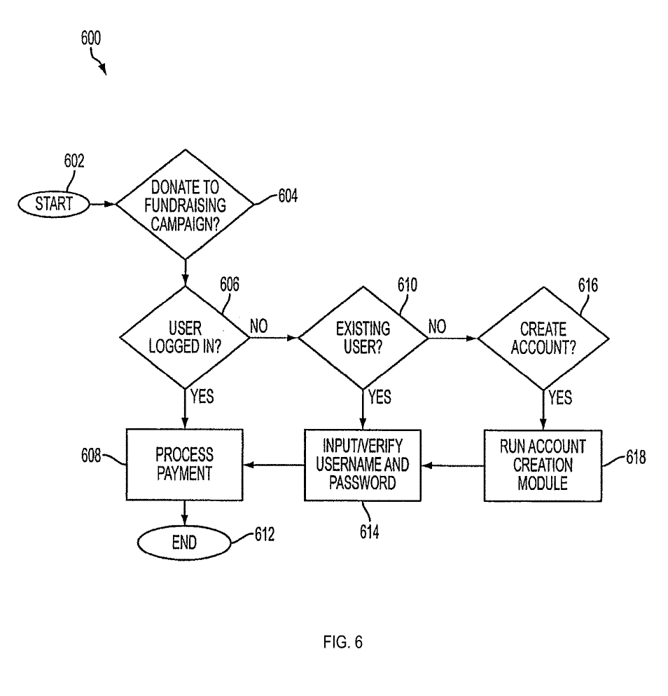

FIG. 6 depicts an exemplary embodiment of a flow chart 600 illustrating an exemplary embodiment of a user interaction fundraising campaign donation process which may be implemented on the system of FIG. 1 Diagram 600 may begin with 602 and may continue immediately with 604.

In 604, a user 108 may donate to a fundraising campaign From 604, flow diagram 600 may continue with 606.

In 606, the fundraising campaign service provider 102 may determine whether the user 108 is logged in or not. From 606, flow diagram 600 may continue with 608 if the user is logged in, or if not, then with 610.

In 608, the fundraising campaign service provider 102 may process donation payment From 608, flow diagram 600 may continue with 612 and may end.

In 610, if a user is not logged in, then it may be determined whether the user is an existing user. From 610, flow diagram 600 may continue with 614 if an existing user, or if not an existing user, may continue with 616.

In 614, if a user is an existing user, then the fundraising campaign service provider 102 may request input and verification of a username and password of the user 108 From 614, flow diagram 600 may continue with 608.

In 616, if a user is not an existing user, then an account may be created for the user. From 616, flow diagram 600 may continue with 618.

In 618, the account creation module 508, discussed further above with reference to FIG. 5, may be executed. From 618, flow diagram 600 may continue with 614.

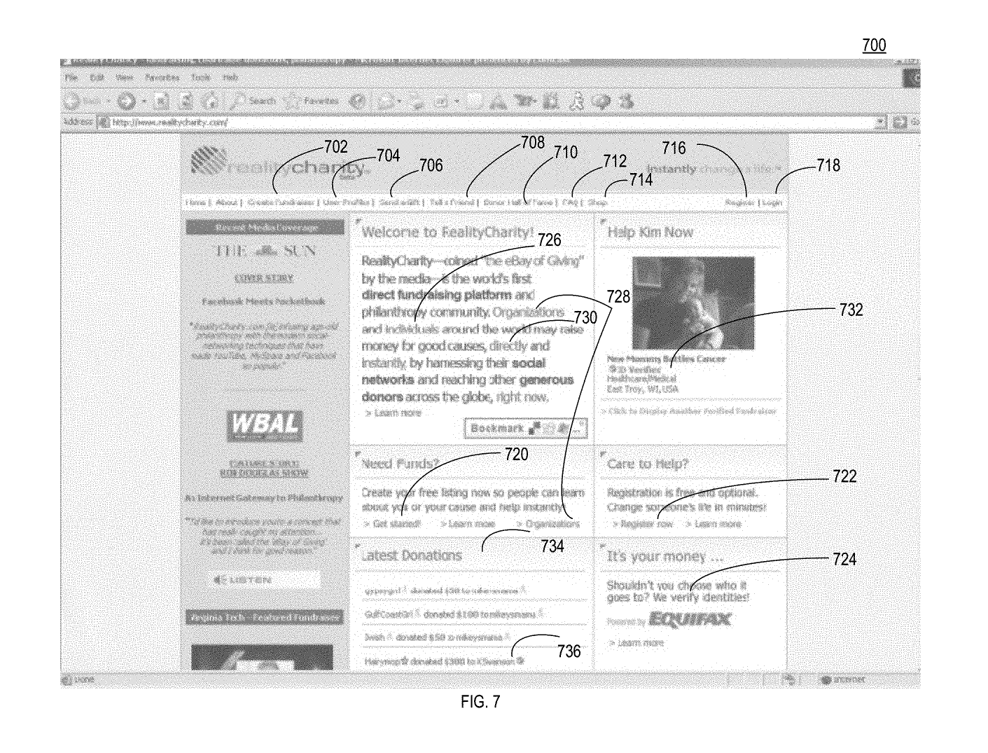

FIG. 7 depicts an exemplary screen shot 700 of an exemplary embodiment of a web-browser-based embodiment of an online electronic fundraising service provider system, according to an exemplary embodiment of the present invention.

FIG. 7 includes an exemplary web-browser-based application, which can be written, for example, but not limited to, in PHP, HTML5 and/or in Java, Javascript, C++, C#, Python, or XML, etc., and can allow for interactive creation of an electronic fundraising campaign, according to an exemplary embodiment

Screenshot 700 can include, in an exemplary embodiment, a create fundraiser 702 hypertext link or button, which can be used to create a new electronic online fundraising campaign, according to an exemplary embodiment. See also create fundraising campaign 510 in FIG. 5, and the description with reference to that figure, according to one exemplary embodiment.

Screenshot 700 can include, in an exemplary embodiment, a user profile 704 hypertext link or button, which can be used to access an optional user profile for a given user of the online electronic fundraising service provider system, according to an exemplary embodiment.

A new user can register by selection of a register 716 hypertext link, or alternatively, a returning user can login using login 718 hypertext link, according to an exemplary embodiment. According to an exemplary embodiment, a user need not register in order to perform some exemplary functions of the application, however to perform other exemplary functions, e.g., to create a fundraiser 702, or to create an exemplary user profile 704, such a user must register, according to one exemplary embodiment.

See also check account details 506, determine existing user 520, and create an account 508, as well as create fundraising campaign 510 in FIG. 5, and the description with reference to that figure, according to one exemplary embodiment.

Send a gift 706 hypertext link or button can be used to send a gift to a user of the exemplary electronic online fundraising service provider system, or to make a gift donation to an online electronic fundraising campaign of the electronic online fundraising service provider system in someone's honor, according to an exemplary embodiment.

Tell a friend 708 hypertext link or button can be used to electronically communicate to a friend to invite them, e.g., by electronic text message, electronic mail message, social media post, etc., of the exemplary electronic online fundraising service provider system, according to an exemplary embodiment.

Donor hall of fame 710 hypertext link or button can be used to electronically navigate to a web page listing an exemplary hall of fame, or listing, or list of donors, e.g., relating to a given campaign, a group of campaigns, a specific campaign, or all campaigns, and/or over a given time interval, etc., according to an exemplary embodiment. Rankings can be provided in one exemplary embodiment to encourage giving to electronic fundraising campaigns, according to an exemplary embodiment

Frequently Asked Questions (FAQ) 712 hypertext link or button can be used to electronically communicate one or more answers to frequently asked questions, and can include, e.g., an ability to search on question topics, and where no present topic is identified, to allow a user to enter a new question, which can have answers posted thereto, adding to the FAQ list, and can be used to anticipate areas of query, and to organize, whether in a forum form, or drill down format, a way to efficiently obtain user instructions, including, e.g., but not limited to, video instructions, audio instructions, media instructions, story boards of exemplary processes, step-by-step processes to perform common tasks, etc., related to user operation and interaction with the exemplary electronic online fundraising service provider system, the social networking system, and computing device client application, according to an exemplary embodiment.

Shop 714 hypertext link or button can be used to electronically access example electronic fundraising campaigns listed in the online electronic fundraising campaign service provider system, alternatively other offerings can be listed, such as, e.g., but not limited to, electronic commerce purchase of goods or services advertised or marketed via the online electronic fundraising service provider system, according to an exemplary embodiment. For example, if a user such as, e.g., but not limited to, a beneficiary, and/or an initiator, etc. such as, e.g., a for profit business beneficiary user, individual, and/or group beneficiary, of the electronic fundraising service provider system seeks funds relating to development of a future good or service, such as, e.g., but not limited to, a new type of 3D printer, one could provide donations to the electronic fundraising campaign for development of the printer, and can allow advance purchase, such that, a portion of the donation can be used toward manufacture of the printer, should the fundraising campaign be successful, and the printer get developed, for example, according to one exemplary embodiment. Alternatively, other goods or services, whether associated with fundraising, raffles, donations, fundraising campaigns, products, branded ware such as, e.g., but not limited to, t-shirts, hats, other goods, can be listed for purchase and/or donation incentive, according to an exemplary embodiment

Register 716 hypertext or button can be used to register a new user account, and login 718 can be used by a registered user to login upon return, as described further above with reference to check account details 506, determine existing user 520, and create account 508, as well as create fundraising campaign 510 in FIG. 5, and the description with reference to that figure, according to one exemplary embodiment.

Get started 720 hypertext link or button instructions can give step by step, textual, rich media, audio, and/or video, etc., or other instructions on how to create a successful online electronic fundraising campaign using the exemplary site, as well as provide access to additional questions and answers also provided, e.g., via the FAQ 712, learn more hypertext link, an organization information 728, or individual information 726, and ways to, e.g., directly 730, or indirectly, raise funds, take advantage of social networks, and donor members, according to an exemplary embodiment.

Electronic fundraising campaigns, according to an exemplary embodiment, can be further verified, and can be identified as verified by exemplary green graphical user interface text 732, or via an exemplary green, or other colored, checkmark, identifying exemplary verifications have been provided to increase the trust level of a given initiator or beneficiary, and/or other user, according to one exemplary embodiment. A captive, and/or third party service provider, or as part of the fundraising service provider can be used to verify identities, such as, e.g, but not limited to, EQUIFAX branded verification service 724, according to one exemplary embodiment.

One or more exemplary donations 734 can be posted on a social media network wall with a donor post, which can show, e.g., but not limited to, an exemplary donation, from an exemplary donor, to an exemplary beneficiary, and can use one or more icons, or color coding, etc. to identify whether a given user is a registered user, and/or whether the user has other features, such as, e.g., but not limited to, a verified identity, and/or a particular level of distinction achieved based on activity, donation volume, frequency, or monetary amount, etc., as well as if the user has a registered user profile, and/or the amount of the donation, further information, as discussed above, etc., according to one exemplary embodiment.

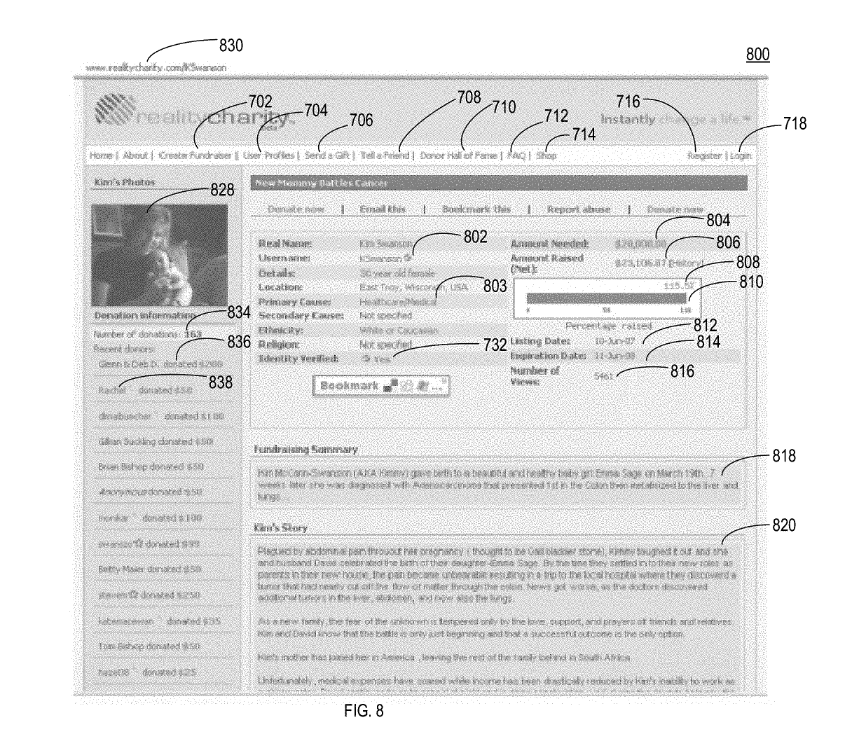

According to an exemplary embodiment, user selection of the user hypertext link or button 736 of Kswanson, can be used to navigate to, e.g, but not limited to, an exemplary beneficiary profile page, and/or one or more exemplary electronic fundraising campaign page(s) associated with the selected user, as can be depicted in screen shot 800 of FIG. 8, according to one exemplary embodiment.

Further, according to an exemplary embodiment, exemplary marketing, and/or advertising can be included, as well as print media, online media, video media, and/or audio interviews about the site, featured fundraisers, such as, e.g., but not limited to, a university, in this example Virginia Tech, etc., can be included, as well as audio and/or video interviews, articles (e.g., cover story in The Sun), media coverage, as well as advertising, including ad banners, demographic and psychographically targeted ads, featured ads, sponsored ads, keyword targeted ads, keyword auctioned ad placement, etc., according to various exemplary embodiments. Further information can be accessed by exemplary hypertext links, such as, e.g., but not limited to, hypertext link to display another verified fundraiser, video teleconferencing button or link, to allow contacting a beneficiary by, e.g, but not limited to, video teleconference, text chat, TWITTER TWEET, SKYPE, GOOGLE HANGOUT, FACEBOOK MESSENGER, etc., allowing providing encouragement to the beneficiary, whether verbally, or textually, according to an exemplary embodiment

Various examples of Commercial Success as evidenced by various awards, and public local, national, and international media acclaim, and in the following, each with sufficient nexus to the claimed invention, since various independent members of the general public note the success of their individual fundraising campaigns to the initiator created fundraising campaign that allows fund raising proceeds to go to the Initiator or Beneficiary and an online electronic social network wall that allows for display of any donor messages, and display of an online electronic scoreboard of cumulative giving functionality:

“Ken and Kristie Sigler have sold cookbooks and football tickets to raise $16,000 for an adoption. For the final $8,700, they are appealing directly to strangers—through a new online clearinghouse that bypasses traditional charities. Reality Charity LLC's Web site, to be unveiled April 3, promises to be an eBay for fundraising. Those in need post appeals to pay off student loans, recover from a natural disaster or avoid a foreclosure. Those wishing to give respond to them directly. The idea is to let donors choose their causes and beneficiaries and make sure their gifts aren't diverted for overhead costs that most charities incur . . . . The Siglers are hoping enough visitors will be moved by their financial plight to help them adopt a boy from Guatemala. The Hilliard, Ohio, couple say they are turning to the direct appeal after striking out with their church and traditional charities. ‘There are a couple of places that provide grants for adoption, but they are few and far between and so many families are adopting,’ said Kristie Sigler. The couple has raised about $200 of the $8,700 from seven donors during a private testing period on the site.”¹ ¹WEB SITE CUTS OUT CHARITY MIDDLEMEN—Folks in need can post appeals, let donors decide whom to support,” Associated Press, Apr. 2, 2007.

“Montgomery Wallis of Sumter, S.C., hasn't spent a day out of the hospital since being born prematurely in March. He weighed 1 pound, 11 ounces at birth, and since then his feeble body has often been covered with crisscrossing wires and ridged tubing. You cannot look at his eyes without wondering if there's something you could do to help. Which may be why people are donating hundreds of dollars for his medical care on a Web site called RealityCharity.com. They're also giving to Christy Gervais, who requested $1,660 to cover back rent she owed after her family left the Gulf Coast after Hurricane Rita destroyed their home and she lost her job. She received all of it in one day from Teresa Mayer of Oakland, Calif., who wrote ‘keep going’ on Gervais' donors page . . . . Some of the donors say they prefer giving this way because they can see their gift going directly to someone in need, even if they can't write the donation off on their taxes . . . ‘People respond to compelling stories, not necessarily cold data and facts but personal stories about people,’ said Anne Glauber, executive vice president for Ruder Finn, a global public-relations firm that has worked with philanthropic groups. ‘What that Web site is doing is offering a potpourri of stories that affect our heartstrings, and we emotionally respond. And you're able to establish relationships with someone, which is what so many people want to do on the Internet.’ . . . . Since its April 2 launch, RealityCharity.com has received more than 1.3 million hits and more than 300,000 page views. Though registration for individuals is free and not required, the site has more than 1,000 registered users. Scores of donors have given anywhere from the minimum $10 to more than $1,000. The average donation is about $50 . . . . He [Blass] has created a donating platform for those whose needs are all but overshadowed by harrowing tragedies that make headlines . . . . Brandon and Roxanne Wallis, the parents of baby Montgomery, posted a personal page, complete with photos, for their son. They appealed for help with financial problems tied to Montgomery's premature birth and stay in a neonatal intensive-care unit more than an hour from their home. Their page has received more than 750 visits and helped raise nearly $600. The Wallises also received encouragement from friends and family they hadn't heard from in years, as well as from strangers.

‘May you both be lifted up and energized by knowing that there are hundreds of people across the United States checking your [page], sending messages of love, and saying prayers for the two of you and little Montgomery,’ wrote a woman [on the wall] who identified herself as Rose Rudisill of Fayetteville, Ark. She sent $100.”² ² “FACEBOOK MEETS POCKETBOOK ON A BALTIMORE-BASED WEB SITE THAT MATCHES DONORS TO STORIES OF NEED,” (cover story), Baltimore Sun, Joe Burris, May 9, 2007.

“When LeeAnne Sherrod heard that her friend had been diagnosed with cancer seven weeks after giving birth to her first child, she experienced a common sense of helplessness. ‘Everyone who knew them got this feeling: What can we do to help?’ said Sherrod, a veterinarian at Mukwonago Animal Hospital. Her 32-year-old friend, Kim McCann-Swanson of East Troy, developed colon cancer during the pregnancy. Neighbors donated money and delivered meals to McCann-Swanson and her husband, but it was their story on a new Web site called RealityCharity.com that prompted dozens of people around the world to contribute more than $20,000 in less than a month to help pay the family's medical bills. The Web site, which launched in April, combines social networking with instantaneous giving in a new model of e-philanthropy. Essentially, it's ‘six degrees of separation’ meets ‘pay it forward’ generosity. The site now hosts about 600 fund-raisers . . . . McCann-Swanson's story, repeatedly forwarded via e-mail, resulted in posts such as this on her “New Mommy Battles Cancer” page [individual person fundraising campaign wall]:

Martina Dalton from Newcastle, Wash., USA gave $50 on 25 Jun. 2007

### Hi Kim,

We are friends of LeeAnne and Steve Sherrod. They love you and your family very much . . . and we love them, so we want to help in whatever way we can! Our thoughts and prayers are with you.

“. . . . McCann-Swanson, who is from South Africa, is undergoing chemotherapy after surgeons removed part of her colon this year. The cancer spread to her liver, abdomen and lungs. She said the response has been ‘unbelievable,’ and that the site has helped her connect with people she hadn't heard from since high school. Other donors she likely will never meet, she said . . . Christy Gervais, a 29-year-old single mother from Texas who was displaced by Hurricane Rita and needed $1,660 to cover her back rent, received help through RealityCharity. A stranger, 27-year-old Theresa Mayer, gave Gervais $1,650 and left two words of encouragement on her donor wall: ‘Keep going.’ ‘Something about her story just touched me,’ Mayer said in a telephone interview from Oakland, Calif. . . . ‘I can sympathize; my mom was a single mom of four, and I know what it's like not to be able to make rent,’ Mayer said. As for McCann-Swanson, her fund-raiser is still active. On Thursday, her donations had exceeded $23,000.”³ ³“DOUBLE-CLICK ON CHARITY: NEW MOM FIGHTING CANCER FEATURED ON PHILANTHROPIC WEB SITE,” (cover story), Erin Richards, Milwaukee Journal Sentinel, Jul. 13, 2007.

“Alexander Blass wants you to give, and he's found a new way for you to do it. Last April, Mr. Blass founded the Web site, RealityCharity.com, which has already racked up 5 million hits and won him the Daily Record's 2007 Innovator of the Year Award . . . . He is on the front end of a trend that is changing the way charitable donations are made.”⁴ ⁴“RAISING THE BAR—New Web site sparks virtual communication between donors and recipients,” Barbara Pash, Jewish Times, Jan. 4, 2008.

“. . . Her page went up late that night. The next morning, Shokek said her cause had already received $500 in donations. ‘I was shocked at who donated, people from my graduate program who I wasn't that close to,’ Shokek said. Having a name and a face and a story I'd written about living with Parkinson's, I think that touched a lot of people.’ Shokek was among the first to use RealityCharity.com, a first-of-its-kind Web site started last April that lets individuals or organizations post content and turn their social networks into fundraising platforms. As the site approaches its first anniversary, founder Alexander Blass said 1,200 campaigns have been started, exceeding his first-year goal of 1,000 . . . John Valenti, of Bel Air, sought out donations through the Web site when his son was diagnosed with leukemia and he took time off from work to care for him. ‘It's a difficult thing to tell people that you need money,’ he said. ‘We got a very strong response.’”⁵ ⁵“REALITYCHARITY.COM NEARS ANNIVERSARY—Baltimore-based Web site allows direct contributions to individuals, organizations,” Aaron Cahall, The Examiner, Mar. 5, 2008.

“Before signing up with the site, a woman with Parkinson's disease tried to raise money for research the old-fashioned way—by talking to friends, says Alexander Blass, the founder of Reality Charity. The result: $100 in donations for a 2006 walk in New York City. The following year, she posted an appeal on Reality Charity—and raised $1,650 from 25 people. Much of the money came from people she knew but hadn't seen in 20 years, according to a posting on the site's Donor Wall. She could only surmise that friends had kept passing her appeal around until it reached those she'd lost touch with.”⁶ ⁶“CHARITY CASES—Social-networking phenomenon makes it easy for donors to promote their favorite causes online,” THE WALL STREET JOURNAL, PAUL B. CARROLL, Jul. 14, 2008.

“Welcome to RealityCharity.com, a first-of-its-kind fundraising website, created by a Baltimore entrepreneur . . . since its launch last April, it has quickly found its niche in today's fast-paced Internet centered world . . . . In need of money for unexpected medical expenses, Kim turned to RealityCharity to spread the word that she needed help. ‘My brother and my sister-in-law both know her, my sister-in-law actually went to summer camp with her.’ (says Stacy, a donor) And with a few clicks of the mouse, Stacy's money went directly to Kim. ‘It cuts out the middleman, It's not like other sites’ (says Stacy, a donor) . . . . It is one of hundreds of donations that helped Kim raise over $30,000. RealityCharity is just over a year old, but already boasts an impressive resume. It has received over 5 million hits, and has hosted over 1,300 fundraising campaigns here in the US, and all around the world . . . . Blass himself is also being honored for his ingenuity. He is the recipient of the Maryland Daily Record's Top Innovator of the Year Award, and the WebAward for Outstanding Achievement . . . he also received the Baltimore Business Journal's Top 40 Under 40 Award.”⁷ ⁷ “REALITY CHARITY COVER STORY,” FOX TELEVISION BALTIMORE, Apr. 15, 2008.

“Lauded as the ‘eBay of Giving’ since its public launch in April, 2007, RealityCharity.com is the world's first direct-giving website and philanthropy community. RealityCharity.com cuts out the middleman between donor and recipient . . . . The web site has a centralized fundraising platform to help individuals in need by providing a voice to those who may not have one. For example, individuals who have been left destitute by Hurricane Katrina no longer have to wait for huge charitable organizations to find them . . . . RealityCharity.com not only provides easy tools for people to pitch in financially and provide momentum for a fundraiser but it also allows users to post words of encouragement and support on a virtual Donor Wall. This can enhance the social network of the individual in need and can create what Blass calls a ‘viral giving’ effect, reaching more people more quickly and, ideally, raise more money. Blass believes that everyone has a story worth hearing and respecting, and RealityCharity.com is providing the megaphone.”⁸ ⁸“INNOVATOR OF THE YEAR MAGAZINE,” Alexander Blass has revolutionized charitable giving (cover story, Top Winner), The Daily Record, September, 2007.

FIG. 8 depicts another exemplary screen shot 800 of an exemplary embodiment of the web-browser-based embodiment of the online electronic fundraising service provider system shown in FIG. 7, further showing a specific exemplary beneficiary's online fundraising campaign page, according to an exemplary embodiment of the present invention

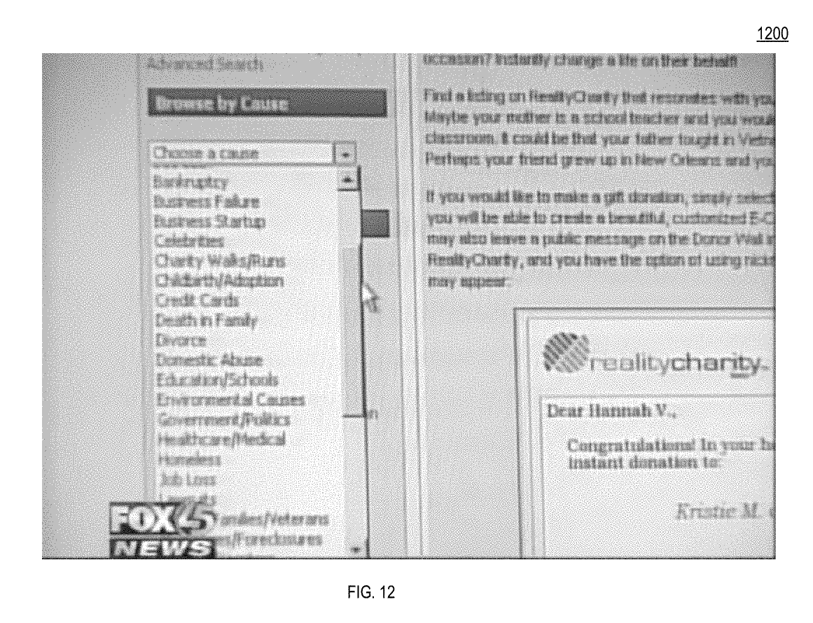

FIG. 8, can for example be a web page associated with an exemplary user Kim Swanson, which according to the exemplary illustrated embodiment can have a verified identity as shown by exemplary indicator 802, according to an exemplary embodiment. The exemplary user webpage 800 for the exemplary online fundraising campaign can include information about the exemplary fundraising campaign, such as, e.g., but not limited to, the primary fundraising category or cause 803 (e.g., but not limited to Healthcare/Medical costs. Business Startup/Investment, Natural Disaster Victims, and many more), as received from an exemplary initiator of the campaign, in this example case, fundraising for Healthcare/Medical costs, an amount of funds needed to be raised 804, as received from an exemplary initiator of the campaign, in this example case, $20,000.00 to be raised, according to an exemplary embodiment. See also the description below with reference to FIG. 12.

The exemplary campaign page 800 can also show an exemplary scoreboard depicting cumulative funds already raised 806, in this case $23.106.87, i.e., in this case exceeding the fundraising amount needed 804, as of the time of viewing of the exemplary campaign page 800, according to an exemplary embodiment. Advantageously, a ratio of the amount raised 806, to the amount needed 804, can be represented on the electronic scoreboard, e.g., but not limited to, textually, such as, e.g., but not limited to, textual representation 808, or graphically, with, e.g., bar chart labels 0, 58, 116, and/or percentage raised, such as, e.g., but not limited to, 115.5%, and/or via an exemplary graphical representation, such as, e.g, but not limited to, a bar chart 810, according to an exemplary embodiment.

The exemplary campaign page 800 can also show a listing date 812, which can represent when the electronic fundraising campaign 800 was created, and expiration date 814, which can represent the initial intended period of expiration of the electronic fundraising campaign 800, according to an exemplary embodiment.

Number of views 816, can track and display, e.g, but not limited to, the number of distinct views, the number of visitors to the page, or the numbers of accesses to, the electronic fundraising campaign page 800, according to an exemplary embodiment.

A summary 818 of the exemplary online electronic fundraising campaign, as well as an exemplary detailed appeal describing the fundraising cause, need, or story 820, an example of an initiator and/o beneficiary social networking wall post of the initiator, or the beneficiary for which the funds are being raised, can be captured by an initiator for display on the electronic fundraising campaign page 800 via the exemplary social networking wall as illustrated in FIGS. 7, 8 and 9, for example, according to an exemplary embodiment. Any content about the beneficiary including, e.g., but not limited to, text 818, 820, image 828, video, audio, and/or other media content, etc., can be provided and/or posted as part of an exemplary social networking wall, including such as, e.g., but not limited to, image 828 of the beneficiary associated with the electronic fundraising campaign 800 of the page, and the title of the campaign, in this case, “New Mommy Battles Cancer” (not labeled) can appear on the page 800, as shown, according to an exemplary embodiment. Additional links (not labeled) can be provided, such as, e.g., but not limited to, donate now, email this, bookmark this, report abuse, Home, and About, hypertext and/or button links, according to an exemplary embodiment, can be included Other information about the campaign, can include, e.g., but not limited to, a username of the initiator, a username of the beneficiary (and the initiator and beneficiary can be the same person), a location of the user, a primary cause category or fundraising type, a secondary cause, any stated ethnicity of the beneficiary, any religion of the beneficiary specified, etc., according to an exemplary embodiment.

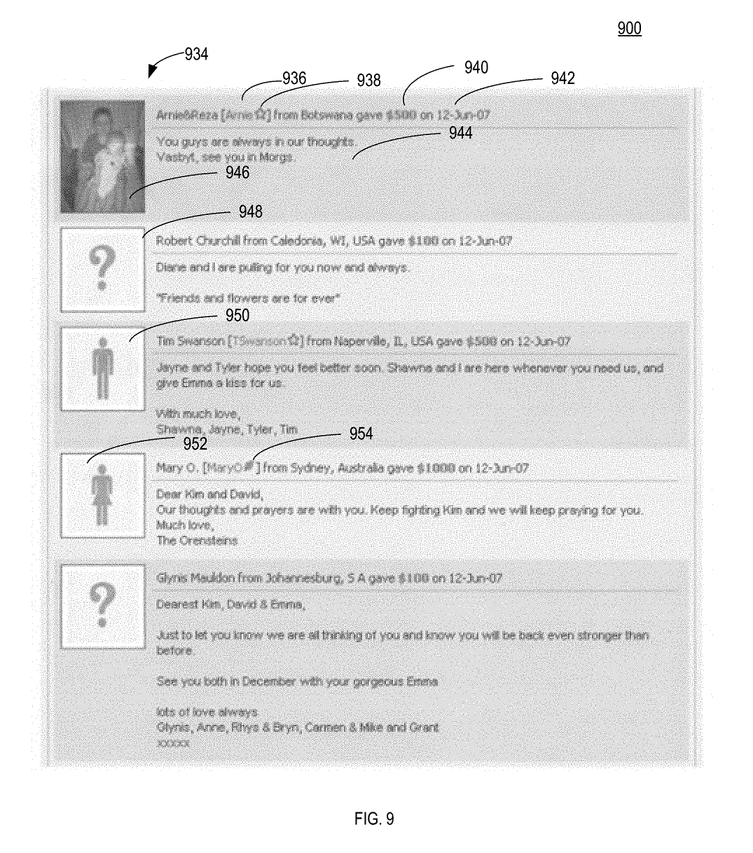

A number of donations 834 can be displayed, and can in an exemplary embodiment include a hypertext link to allow opening a listing 900 of donations as described further below with reference to FIG. 9, according to an exemplary embodiment. Recent donors' donations to this exemplary electronic fundraising campaign, or funds raised 836, 838, can be listed as well on the electronic fundraising campaign page 800, according to an exemplary embodiment, and indication such as, e.g, but not limited to, a link or button, can be provided as to, e.g., but not limited to, whether a donor is a registered or unregistered user, and/or, whether the donor user has its own profile, has been verified, etc. according to an exemplary embodiment. Colors, fonts, shading, and/or icons, etc., can be used to indicate further information about a user, such as, e.g., but not limited to, a star representing a particular level of distinction achieved based on activity, donation volume, frequency, or monetary amount, or registration status, according to an exemplary embodiment.

FIG. 9 depicts an exemplary screen shot 900 of an exemplary embodiment of a list 934 of an exemplary donor wall of an exemplary social networking donor wall, or of exemplary donor posts 946, 948, 950, 952, with exemplary fund raising donations 940 and exemplary donor text 944 and/or image 946 posts, of an exemplary web-browser-based embodiment of an exemplary social networking wall donor or other user post(s) of the online electronic fundraising service provider system shown in FIGS. 7 and 8, according to an exemplary embodiment of the present invention.

According to an exemplary embodiment, if a donor does not have an image uploaded, the system can prompt the user to add an image with, e.g., a question mark, or the like to prompt the user to provide an image, if a user wishes to remain anonymous, or would rather not provide their image, but may wish to indicate the user's gender, for example, the post can alternatively show a female figure or male figure, or the like, according to an exemplary embodiment of the present invention.

The individual list item of the list 934 can include the donor or funder's name, or username, or account name if registered, or be anonymous, and/or any indication of the user, such as, e.g., but not limited to, a color indicator; a symbolic indicator, an icon, a star, leaf, etc., to represent particular information about the user, e.g., an indication can be provided if the user is verified, or not, or a particular level of distinction achieved based on activity, donation volume, frequency, or monetary amount; the listing can include an amount 940, of the donation or funds provided by the donor user to the campaign in this donation, the location and/or country (e.g., Botswana was shown in example) from which the donor originates, the date 942 on which the donation or funds were provided, according to an exemplary embodiment of the present invention.

Applicant's claimed invention provides an electronic platform enabling creation of and management of electronic online fundraising campaigns such as, e.g., but not limited to, for a for profit business, company, corporation, association, individual, person, group, etc., using a fundraising electronic social networking system computing device, and displaying on a graphical user interface, as well as an electronic social networking wall, including providing display of cumulative giving of electronic donations, and transaction state of initiation of an electronic disbursement process of electronically distributing at least a portion of funds raised according to distribution information previously collected. This is not something that one can do in a person's head. Applicant's claimed invention sets forth a tailored specifically set forth and claimed computer technology solution to a technological problem, which achieves more rapid electronic distribution of funds and transaction state of electronic initiation of the electronic distribution process of electronically distributing funds raised. This is a technology solution to a technology problem, and is not something that could be performed in someone's head.

Embodiments of Applicant's claimed invention provides for a technological improvement by providing an improved graphical user interface, that displays electronic posts of, e.g., donations or contributions, investments, or other electronic social network posts, which may include electronic individual donation posts or electronic indications of electronic contributions to an online electronic fundraiser and the electronic indication of electronically calculated cumulative value of funds raised, which is dynamically updated, and allows for electronic initiation of a process of electronic distribution and electronic tracking and display on the graphical user interface of transaction state of the electronic disbursement process of the electronic funds transfer, which together lead to more rapid distribution of funds and have been found to achieve a viral effect of encouraging increased or additional donations, and certainly the more rapid technological electronic distribution of funds. Embodiments of the technologically improved electronic system, further provide for initiation of the electronic disbursement process, and tracking of a transaction state of the process of disbursement, allowing display on the graphical user interface of the transaction state, of the electronic distribution of at least a portion of the funds from the donor computing device to beneficiary computing device or initiator computing device, providing assured, efficient verifiable delivery and faster transmission and receipt of funds via electronic disbursement than conventional systems that used manual payment systems and the like. Embodiments provide for electronic donations and electronic disbursement process giving. The improved electronic graphical user interface (GUI), with display of the electronic social network media posts, the cumulative giving calculated value, the transaction state of the initiation of the electronic distribution of funds, according to embodiments of Applicant's claimed invention are not routine or conventional, as conceded in the action, but rather include creating on a fundraising electronic social networking system computer device, an electronic graphical user interface that displays an electronic page for the electronic online fundraising campaign, including an associated electronic social networking wall with continually updated social network posts, from individual donors computing devices, and an electronic scoreboard with the individual donations data indicative of values transformed into dynamically updated electronic cumulative giving total display values, as well as display of transaction state of electronic initiation of electronic distribution of funds raised. This computerized method provides substantial performance benefits by getting funds to those in need, and without the middleman of opaquely contributing through a non-profit entity as done historically, and by eliminating delays in normal processing, and by bringing efficiencies by reducing overhead and costs associated with conventional manual processes of fundraising. It would be impossible to provide the claimed invention without a computer, and the electronic communications network used to deliver the GUI to client workstations of initiator computer devices, beneficiary computer devices and donor computing devices, as the computer is absolutely essential and required, as the system would not work without these technological parts and the system's improvements over routine and conventional systems. Embodiments of Applicant's claimed invention enable electronic giving with substantial performance improvements through electronic disbursement, and viral giving effects due to constant, dynamic update of the social network wall and/or electronic scoreboard and/or cumulative funds raised associated with the created online fundraising campaign. Embodiments of Applicant's claimed invention thus provide most clearly a substantial improvement over any alleged abstract idea, and thus is proper subject matter for patenting, and as novel and nonobvious is worthy and entitled to allowance as patentable.

An enormous technical problem for, e.g., but not limited to, for-profit businesses, groups, and/or persons' in financial need, etc., whose computing devices are not able to efficiently connect with computing devices of others willing to help, absent the electronic communications network and online electronic fundraising social networking system computer device and system to allow electronically managing, initiating, and displaying transaction state of electronic distribution to rapidly execute electronic funds distribution to result in direct electronic transmission of financial assistance in a time-critical situation to computing devices of those in need. Before Applicant's claimed invention, individual beneficiaries computing devices (of those such as a person, family, or group) had no centralized technological platform to create an online fundraising campaign and rapidly and efficiently reach out to, create, manage raise, and electronically receive initiation of electronic disbursement of money from the individual beneficiaries' social networks, and social networks of those social networks, and so on, for funds, financial investments, funds raised, capital, capital investment, or contributions, etc. Medical bills, for example, have been a leading cause of bankruptcies in the United States for many years. As reported by CNBC in 2013, “Bankruptcies resulting from unpaid medical bills will affect nearly 2 million people this year-making health care the No. 1 cause of such filings, and outpacing bankruptcies due to credit-card bills or unpaid mortgages, according to new data. And even having health insurance doesn't buffer consumers against financial hardship.”

Embodiments of Applicant's claimed invention solve this technical problem of electronically disbursing funds and maintaining and displaying transaction state, addresses a long felt unmet need in society by allowing a person in need to create an online fundraising campaign for themselves, their family, a group, for-profit business, or a friend, and spread the word and promote the online fundraising campaign through the person's social networks. Since a potential donor, investor, funder, capital investor, contributor, or other user knows who the beneficiary is, and may have a direct or indirect personal connection to them, thus they may be more inclined to help and thus a donation or contribution from the donor, contributor, or other user can benefit in a timely manner due to initiation of electronic disbursement of funds to the beneficiary, such as, e.g., an individual beneficiary or group (not a nonprofit organization), in a time critical situation. Similarly, these donors can then spread the word about the person or family in need of raising funds, for example, and promote the online fundraising campaign through their social network and encourage others to contribute funds as well, generating a “viral giving” effect.

It is very important to note that the Applicant's claimed invention is starkly different than prior methods of online fundraising platforms that focused on fundraising for nonprofit organizations only, whereas embodiments of the claimed invention are focused on solving a technical problem as well as a long felt, unmet societal need for online fundraising for individuals, families, and groups in financial need. Nonprofit fundraising is extremely different than personal fundraising for a number of legal, technical, and psychological reasons. For example, nonprofit organizations are governed by specific legal limitations in how they raise and disburse funds, and their fundraising efforts are replete with well documented problems such as, e.g., inefficiency, waste, fraud, and lack of transparency, to name a few.

Many people are more inclined to give directly to an individual, family, or group beneficiary (not a nonprofit) as claimed in an embodiment of the claimed invention because person to person giving is superior to contributing to a nonprofit organization in many ways, including, e.g.: 1) when one gives to a nonprofit, one is legally prevented from directing the funds to a specific person of one's choosing, rather contributions are directed to a broad pool of funds, 2) one will never know if one's money went to anyone at all (versus overhead expenses such as salaries), much less to whom, 3) overhead expenses at nonprofits can be notoriously high, sometimes well above 50% of funds raised, leading to enormous inefficiency, and donor disinterest and skepticism, 4) it can be weeks, months, or often years before funds are distributed from a nonprofit to those the nonprofit claims to help, leading to donor anger and those in need not getting the funds in a timely fashion when the beneficiaries need it the most, if ever, and 5) fraud and waste are an enormous problem in some nonprofit fundraising, see for example, as reported by many media outlets surrounding Hurricane Katrina fundraising, including the New York Times in their article entitled, “Breathtaking’ Waste and Fraud in Hurricane Aid.”

So, in the case of an emergency, after a flood, a hurricane, etc., e.g., an individual who has lost their home, can gain timely benefit from Applicant's system's technological features' efficiencies, by providing an improved technological solution, namely an electronic online fundraising campaign hosting system, including features that provide a more timely and efficient receipt and initiation of electronic disbursement of the funds raised to a user-selected or -chosen beneficiary, which could be, e.g., an individual beneficiary, a group beneficiary, or a for-profit beneficiary. A beneficiary can immediately benefit in a time critical manner from the improved, efficient, technological solution that enables online fundraising campaigns to be created in the timely manner noted.

Embodiments of Applicant's claimed invention have resulted in unexpected results, namely, the electronic system has enabled increased fund raising from user validation resulting in viral giving i.e. social network posts about an online fundraising campaign results in additional users donating or contributing to a given campaign. When potential donors or contributors electronically view electronically displayed electronic social network wall posts, additional donor computing devices are attracted to provide electronic donations to the system, as well as electronically display electronic cumulative fund raising calculated values encourages additional giving by users on user devices, particularly driven by the exemplary claimed features that the funds raised can be electronically disbursed, and electronically the initiation of disbursement to, and can be tracked by transaction state, and displayed in a graphical user interface by electronic viewing on, e.g., an individual beneficiary computing device chosen by the contributor computing device (i.e not a not profit), which in turn builds trust, community, momentum, excitement, and encourages users to use electronic devices to electronically give donations, investments, or contributions, electronically distributed, as well.

Alternatively, electronic distribution of funds raised can be accomplished using, e.g., but not limited to, PAYPAL, VENMO, ZELLE, WEPAY, and/or other electronic payment systems, according to one exemplary embodiment.

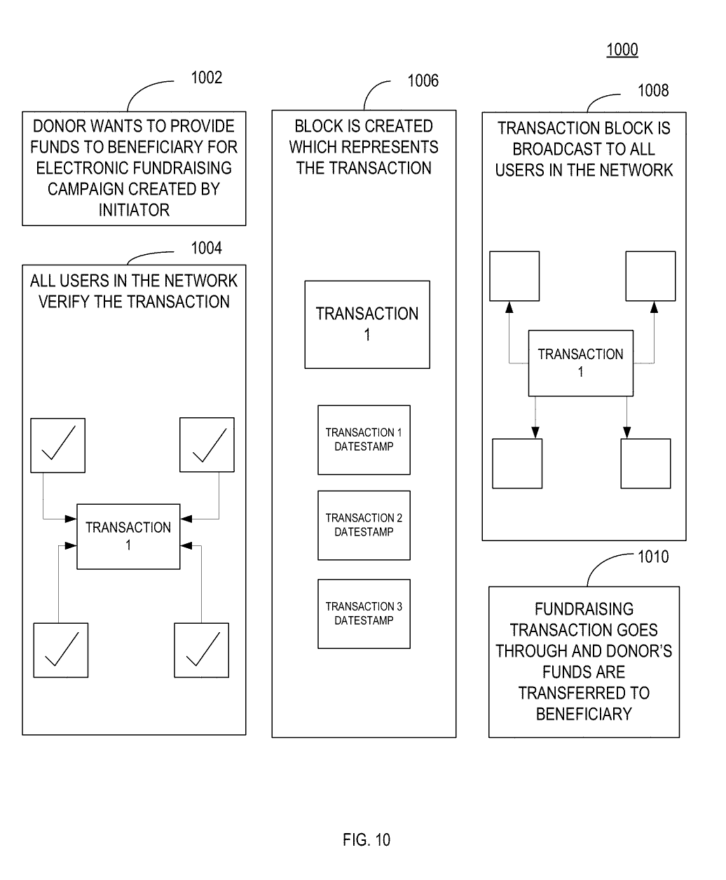

FIG. 10 depicts an exemplary flow diagram 1000, according to one exemplary embodiment of an exemplary block chain electronic funds distribution process, according to one exemplary embodiment.

A distributed ledger is a type of database that is shared, replicated, and synchronized among the members of a decentralized network, according to one exemplary embodiment. The distributed ledger records the transactions, such as the exchange of assets or data, among the participants in the network, according to one exemplary embodiment.

Participants in the network govern and agree by consensus on the updates to the records in the ledger, according to one exemplary embodiment. No central authority or third-party mediator, such as a financial institution or clearinghouse, is involved, according to one exemplary embodiment. Every record in the distributed ledger has a timestamp and unique cryptographic signature, thus making the ledger an auditable, immutable history of all transactions in the network, according to one exemplary embodiment.

A block is record of a new transaction, according to one exemplary embodiment When a block is completed, the block is added to the chain, according to one exemplary embodiment. A blockchain network operates as a distributed ledger, according to one exemplary embodiment. Bitcoin (an unregulated, digital currency, which uses blockchain technology as its transaction ledger) owners, e.g., have a private password (a complex key) to an address on the chain, which is where the owner's ownership is recorded, according to one exemplary embodiment.

Rather than relying on a third party, such as a financial institution, to mediate transactions, member nodes in a blockchain network use a consensus protocol to agree on ledger content, and cryptographic hashes and digital signatures to ensure the integrity of transactions, according to one exemplary embodiment

Consensus ensures that shared ledgers are exact copies, and lowers risk of fraudulent transactions, because tampering has to occur across many places at exactly the same time, according to one exemplary embodiment. Cryptographic hashes, such as the SHA256 computational algorithm, ensure that any alteration to transaction input—even the most minuscule change—results in a different hash value being computed, which indicates potentially compromised transaction input, according to one exemplary embodiment. Digital signatures ensure transactions originated from senders (signed with private keys) and not imposters, according to one exemplary embodiment.

The decentralized peer-to-peer blockchain network prevents any single participant or group of participants from controlling the underlying infrastructure or undermining the entire system, according to one exemplary embodiment. Participants in a network are all equal, adhering to the same protocols, according to one exemplary embodiment. The participants can be individuals, state actors, organizations, or a combination of all these types of participants, according to one exemplary embodiment.

At its core, the system records the chronological order of transactions with all nodes agreeing to the validity of transactions using the chosen consensus model, according to one exemplary embodiment. The result is transactions cannot be altered or reversed, unless the change is agreed to by all members in the network in a subsequent transaction, according to one exemplary embodiment.

According to an exemplary embodiment, block diagram 1000 can begin at 1002 where a donor or user wants to provide funds or donations to a beneficiary for an electronic fundraising campaign, which is created by an initiator, according to one exemplary embodiment A transaction is initiated by the donor/user, and all users in the network verify the transaction 1004, according to one exemplary embodiment. Then a block is created 1006, the block representing the transaction, according to one exemplary embodiment. As each transaction occurs, and the parties agree to its details, the transaction is encoded into a block of digital data, is uniquely signed and/or identified, according to one exemplary embodiment. Each transaction is datestamped, and is connected to the before and after it, creating an irreversible, immutable chain, according to one exemplary embodiment Then the transaction block is broadcast to all users in the network 1008. Blocks are chained together, preventing any block from being altered or a block being inserted between two existing blocks, according to one exemplary embodiment. Then the fundraising transaction goes through and the donor/user party's funds are thereby transferred to the beneficiary party 1010, according to one exemplary embodiment. The blockchain creates a shared distributed system of record among the service provider business network members (users), eliminating a need to reconcile disparate ledgers, according to one exemplary embodiment. Each member of the network must have access privileges, or proper permissions, according to one exemplary embodiment. Information is shared only on a need-to-know basis, according to one exemplary embodiment. Consensus is required, according to one exemplary embodiment, from all members, and all validated transactions are permanently recorded, i.e., immutably, according to one exemplary embodiment. Even a system administrator cannot delete a transaction, according to one exemplary embodiment.

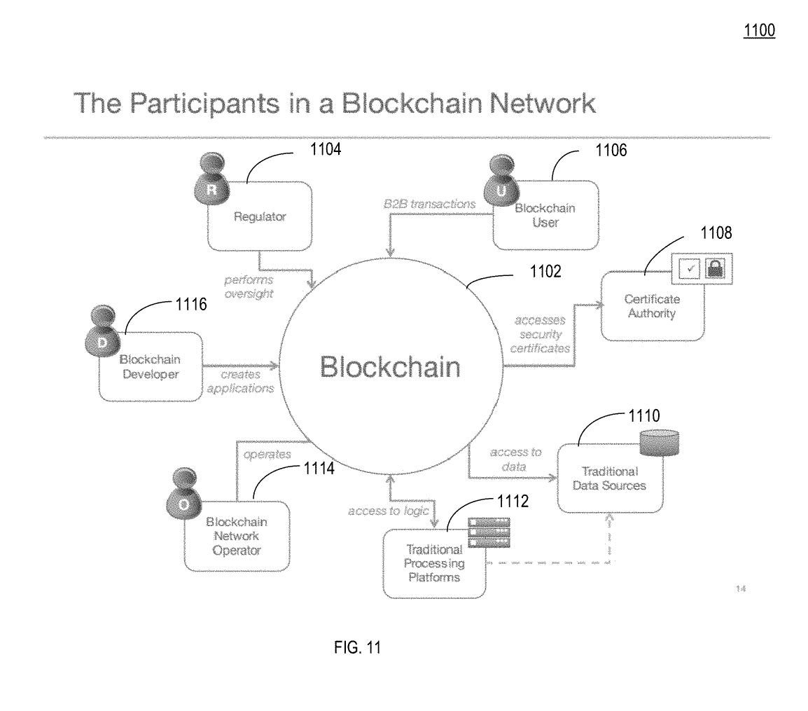

FIG. 11 depicts an exemplary block diagram 1100 illustrating an exemplary block chain network with exemplary participants as could be included in an exemplary embodiment of the present invention.

An exemplary blockchain technology includes, e.g., but not limited to, a shared, permissioned ledger visible to authenticated members, is append only and provides a single source of truth, a consensus protocol used by all members of the network allows only network verified transactions to update the ledger-cryptography provides tamper proof integrity, through authentication; and chaincode stored on validating peer nodes, according to one exemplary embodiment.

FIG. 11 depicts the exemplary block diagram 1100 illustrating an exemplary block chain network 1102, which can include exemplary participants including, but not limited to, the blockchain system 1102, over which a regulator 1104 performs oversight, block chain user 1106 can perform B2B (shown), and/or B2C (not shown but similar), and/or C2C (not shown, but similar), transactions, in this case, fundraising, the blockchain system 1102 accesses security certificates obtained from a certificate authority 1108, the blockchain system 1102 transfers and/or provides access to data with traditional data sources 1110, the block chain system 1102 interacts with access to logic to and from traditional processing platforms 1112, which indirectly allows access to the traditional data sources, the blockchain system 1102 is operated by a blockchain network operator 1114, applications are created for the blockchain system 1102 by a blockchain developer 1116, according to an exemplary embodiment of the present invention.

FIG. 12 depicts another exemplary screen shot 1200 of an exemplary embodiment of the web-browser-based embodiment of the online electronic fundraising service provider system shown in FIG. 7, further showing an exemplary partial but far from exhaustive list 1202 of the exemplary numerous types of online fundraising campaign categories and causes conceived of, supported, implemented, and hosted by the exemplary system, according to an exemplary embodiment of the present invention Exemplary partial list 1202 exemplary fundraising categories include, e.g., but not limited to: Bankruptcy, Business Failure, Business Startup, Celebrities. Charity Walks/Runs, Childbirth/Adoption. Credit Cards, Death in Family, Divorce, Domestic Abuse, Education/Schools, Environmental Causes, Government/Politics, Healthcare/Medical, Job Loss, Lawsuits, Military Families/Veterans, Real Estate, and Foreclosures, in an exemplary embodiment. In an exemplary embodiment, exemplary visitors and users of the online electronic fundraising service provider system may select from an exemplary drop-down menu 1204 to browse by exemplary cause (fundraising category) the various exemplary online fundraising campaigns hosted by the exemplary online electronic fundraising service provider system to suit their exemplary particular interests, or for a more targeted and specific search of the exemplary online fundraising campaigns, may click on an exemplary advanced search 1206 hypertext link to specify and enter additional exemplary search criteria.

According to an exemplary embodiment, if a donor does not have an image uploaded, the exemplary system can prompt the user to add an image with, e.g., a question mark, or the like to prompt the user to provide an image, if a user wishes to remain anonymous, or would rather not provide their image, but may wish to indicate the user's gender, for example, the post can alternatively show a female figure or male figure, or the like, according to an exemplary embodiment of the present invention.

The exemplary individual list item of the exemplary list 934 can include the donor or funder's name, or username, or account name if registered, or be anonymous, and/or any indication of the user, such as, e.g., but not limited to, a color indicator, a symbolic indicator, an icon, a star, leaf, etc. to represent particular information about the user, e.g., an indication can be provided if the user is verified, or not, or a particular level of distinction achieved based on activity, donation volume, frequency, or monetary amount; the listing can include an amount 940, of the exemplary donation or funds provided by the donor user to the campaign in this donation, the location and/or country (e.g., Botswana was shown in example) from which the exemplary donor originates, the date 942 on which the donation or funds were provided, according to an exemplary embodiment of the present invention.

According to an exemplary embodiment, data of users (such as, e.g., but not limited to, passwords, personal data, paypal and/or other electronic disbursement system information, and the like, etc.) and/or of online electronic campaigns, etc., can be encrypted using, e.g., but not limited to, public key encryption, use of hashing algorithms, and the like, and can be decrypted when access to the data is needed, etc. Various exemplary embodiments can include use of, e.g, but not limited to, crypto chips and/or encryption algorithms, and the like, to use encryption to protect private data, including, e.g., data relating to electronic disbursement and/or innovative payment processing systems such as, discussed in, the contents of which are incorporated herein by reference in their entirety, public ledgers such as, e.g., but not limited to, various exemplary embodiments, can be included in systems such as, as set forth in US20170169425, U.S. Pat. No. 8,768,828, US20170300978, the contents of which are incorporated herein by reference in their entirety, distributed ledgers, see for various exemplary embodiments, systems as set forth in US20180322543, the contents of which is incorporated herein by reference in its entirety, etc., use of highly scaleable graph databases to support advantageous user scaleability and increased performance (decreased response time) of your underlying social network, according to an exemplary embodiment. According to various exemplary embodiments, fraud detection enhancements can be included, including, e.g., but not limited to, machine learning to identify expected user habits, and can use such artificial intelligence tools, for example, to identify, e.g., fake user accounts, and the like, fraudulent activity, etc., according to an exemplary embodiment of the present invention.

Various enhancements, according to an exemplary embodiment, can be included in various exemplary embodiments including, e.g., but not limited to, use of artificial intelligence, including, e.g., but not limited to, expert systems, neural networks, machine learning, heuristics and statistical methods, pattern recognition techniques, principal component analysis (PCA), or singular value decomposition (SVD) techniques, according to an exemplary embodiment, factorization of real or complex matrices, least squares and polynomial fitting, use of constrained linear regression techniques to ignore outliers, according to an exemplary embodiment, K-means unsupervised clustering to iteratively group points in clusters and identify cluster centers, logistic regression constrained linear regression with nonlinearity and/or maximum entropy classifier techniques, according to an exemplary embodiment, support vector machines (SVM) linear models and margin-based loss function optimization, according to an exemplary embodiment, feed forward neural networks or multi-layered perceptron autoencoders for classification, according to an exemplary embodiment, according to an exemplary embodiment, and unsupervised feature learning, use of convolutional neural networks machine learning for image classification, segmentation, and object detection, according to an exemplary embodiment, recurrent neural networks applying recursive application of weighting to model sequence tasks for, e.g., but not limited to, text classification, machine translation and modeling, according to an exemplary embodiment, conditional random field models for image segmentation, decision trees such as, e.g., but not limited to, random forests, boosting trees, etc., for data point classification, according to an exemplary embodiment, use of AI bots for FAQ like user help and support, strategy learning techniques, reinforcement learning, temporal difference learning and other prediction-based machine learning techniques, monte carlo analysis, dynamic programming (DP) ideas, etc., according to an exemplary embodiment of the present invention

Various other enhanced features, according to an exemplary embodiment, can include, e.g., but not limited to, targeting one or more donors, investors, users, business investor, with potential online electronic fundraising campaigns, offerings, and/or advertising, and/or goods, and/or services offerings that can be expected based on computation analysis to be of particular interest to a given user, investor, donor that based on behavior demographics (psychographics) can provide online electronic fundraising campaigns for potential investment/donation/funds giving, based on exemplary user interests, and/or search results, demographics, behavioral demographics, psychographics, psychographically targeting adds, sponsored advertisements, banners, search results, featured and/or sponsored search results, keyword searching, auctioning of keyword per click advertising for ads targeted at those considering online fundraising campaigns, etc., according to an exemplary embodiment.

Various enhancements, according to an exemplary embodiment, can be included in various exemplary embodiments including, e.g., but not limited to, mobile application enhancements, e.g., use of mobile device (e.g., iOS, Android, etc.) app based implementations, mobility advantaged sensing of location by GPS, mobile camera image capture, customization of giving appeal templates, widgets, APIs, and video production templates and image editing and customization techniques, techniques to increase giving, e.g., prompting with touchscreen buttons with suggested donation amounts, preprompting of donation requests, voice recognition of natural language fundraising donation requests, etc Various exemplary embodiments of Applicants, can be included in systems as set forth in U.S. Pat. No. 8,473,421, the contents of which is incorporated herein by reference in its entirety. Use of an exemplary touchscreen sensitive screen to receive fundraising investments, donations, contributions, etc., according to an exemplary embodiment.

Various enhancements, according to an exemplary embodiment, can be included in various exemplary embodiments including, e.g., but not limited to, Social media technology, including, e.g., but not limited to, social media network newsfeed campaigns, embedding incentives for contributing, investing, donating in online fundraising campaigns, allowing creation of short term content, such as, e.g., but not limited to, snapchat videos about giving, click here to donate. Donor Stories, Donor histories, disappearing content, liking, emojis, giving emojis, donation emojis, business fundraising emojis, etc., enhanced verification of users, ranked/graded verification of users, according to an exemplary embodiment of the present invention. Exemplary ranking of users and campaigns can be made using any of various scoring systems including, e.g., but not limited to, in one exemplary embodiment, can further include systems as set forth in US US20120316916, the contents of which is incorporated herein by reference in its entirety.

Various enhancements, according to an exemplary embodiment, can be included in various exemplary embodiments including, e.g., but not limited to, gamification of giving, donor giving integrated into Twitch, YouTube, Facebook Videos, Stories, and Live, Snapchat Stories, Instagram stories, etc., according to an exemplary embodiment of the present invention.

Various enhancements, according to an exemplary embodiment, can be included in various exemplary embodiments including, e.g., but not limited to, campaign templating techniques, e.g., recommendations on description length, guides, effective strategies for increased giving, suggestions, help, etc., according to an exemplary embodiment of the present invention.

While various embodiments of the present invention have been described above, it should be understood that they have been presented by way of example only, and not limitation Thus, the breadth and scope of the present invention should not be limited by any of the above-described exemplary embodiments, but should instead be defined only in accordance with the following claims and their equivalents.

What is claimed is:

1. A system of electronically creating, electronically managing, and electronically hosting a plurality of online electronic fundraising campaigns and of electronically providing for electronic distribution of funds, and transaction state, by electronic initiation of electronic distribution of funds raised, comprising:
at least one computer memory; and
at least one computer processor, coupled to said at least one memory, said at least one computer processor configured to electronically:
receive an electronic request to create a new electronic fundraising campaign including social networking, electronic scoreboard, and electronic disbursement;
create the new electronic fundraising campaign comprising;
wherein said at least one computer processor is configured to electronically:
receive fundraising campaign information comprising at least one or more of:
at least one or more of monetary amount sought, title, description categories, themes, or listing details of said new electronic fundraising campaign;
receive at least one, or more of:
receive at least one donation from a donor user computing device to contribute funds to said new electronic fundraising campaign, wherein said at least one donation comprises at least one, or more, of:
receive an electronic request to make an anonymous donation to said new electronic fundraising campaign;
receive an electronic request to make an eponymous donation to said new electronic fundraising campaign; or
receive an electronic request to make a gift donation to said new electronic fundraising campaign; or
receive an electronic request for an electronic link to said new fundraising campaign;
receive any request to display data relating to donors computing devices;
display in response to said any request to display data relating to donors computing device, a donor display result;
receive at least one social network wall post related to said new electronic fundraising campaign;
display said at least one social network wall post related to said new electronic fundraising campaign;
accumulate a plurality of said at least one donation into accumulated donations related to said new electronic fundraising campaign;
create an electronic scoreboard of said accumulated donations related to said new electronic fundraising campaign; and
initiate an electronic disbursement process and maintain transaction state of the electronic distribution process of at least a portion of the funds raised from said new electronic fundraising campaign;
wherein the initiation of the electronic disbursement process is performed at least one, or more, of:
electronically, at least one, or more, of:
as soon as funds are received,
in a batch process at a later time,
at a periodic time interval,
at a time when a donor computing device, initiator computing device, beneficiary computing device, payment processor computing device, online fundraising service provider computing device, or recipient computing device requests the disbursement, or
in a payment disbursement process; or
electronically, by electronic funds transfer (EFT), at least one, or more, of:
as soon as funds are received,
in a batch process at a later time,
at a periodic time interval,
at a time when the donor computing device, initiator computing device, beneficiary computing device, payment processor computing device, online fundraising service provider computing device, requests the disbursement computing device, or
in a payment disbursement process; and
display on a graphical user interface the transaction state of the electronic distribution process.

2. The system according to claim 1, further comprising wherein said at least one computer processor is configured to electronically at least one or more:
receive any third party identity authentication electronic request;
perform the electronic third party identity authentication in response to said any third party identity authentication electronic request; or
display a third party identity authentication electronic result in response to said any third party identity authentication electronic request, and update the user account with said third party identity authentication electronic result in response to said any third party identity authentication electronic request.

3. The system according to claim 2, wherein said third party identity authentication electronic result comprises a social network wall post from at least one user computing device.

4. The system according to claim 1, wherein said create an electronic scoreboard of said accumulated donations comprises wherein said at least one computer processor is configured to electronically, at least one, or more, of:
provide a textual representation of said accumulated donations; or
provide a graphical representation of said accumulated donations;
provide at least one, or more, of:
provide at least one electronic tool comprising computer instruction code; or
provide at least one electronic tool to electronically publicize, or electronically promote, said new electronic fundraising campaign.

5. A computer implemented method of electronically creating, electronically managing, and electronically hosting a plurality of online electronic fundraising campaigns and of electronically providing for electronic distribution of funds, and transaction state, by electronic initiation of electronic distribution of funds raised, comprising electronically:
receiving, by at least one computer processor coupled to at least one memory, an electronic request to create a new electronic fundraising campaign including social networking, electronic scoreboard, and electronic disbursement;
creating, by the at least one computer processor, the new electronic fundraising campaign comprising:
receiving electronically, by the at least one computer processor, fundraising campaign information;
receiving electronically, by the at least one computer processor, at least one, or more of: monetary amount sought, title, description categories, themes, or listing details of said new electronic fundraising campaign;
receiving electronically, by the at least one computer processor, optional upload of files or images of said new electronic fundraising campaign;
receiving electronically, by the at least one computer processor, at least one, or more of:
receiving electronically, by the at least one computer processor, at least one donation from a donor user computing device to contribute funds to said new electronic fundraising campaign, wherein said at least one donation comprises at least one, or more, of:
receiving electronically, by the at least one computer processor, an electronic request to make an anonymous donation to said new electronic fundraising campaign;
receiving electronically, by the at least one computer processor, an electronic request to make an eponymous donation to said new electronic fundraising campaign; or
receiving electronically, by the at least one computer processor, an electronic request to make a gift donation to said new electronic fundraising campaign; or
receiving electronically, by the at least one computer processor, an electronic request for an electronic link to said new fundraising campaign;
receiving electronically, by the at least one computer processor, any request to display data relating to donors or donors computing devices;
displaying electronically, by the at least one computer processor, in response to said any request to display data relating to donors or donors computing device, a donor display result;
accumulating electronically, by the at least one computer processor, a plurality of said at least one donation into accumulated donations related to said new fundraising campaign;
creating electronically, by the at least one computer processor, an electronic scoreboard of said accumulated donations related to said new fundraising campaign; and
initiating electronically, by the at least one computer processor, an electronic disbursement method and maintaining electronically transaction state of the electronic disbursement method of at least a portion of the funds raised from said new electronic fundraising campaign;
wherein the initiating of the electronic disbursement method is performed at least one, or more, of:
electronically directly, or electronically indirectly between a plurality of entities;
electronically, at least one, or more, of:
as soon as funds are received,
in a batch process at a later time,
at a periodic time interval,
at a time when a donor computing device, initiator computing device, beneficiary computing device, payment processor computing device, online fundraising service provider computing device, or recipient computing device requests the disbursement, or
in a payment disbursement process; or
electronically, by electronic funds transfer (EFT), at least one, or more, of:
as soon as funds are received,
in a batch process at a later time,
at a periodic time interval,
at a time when the donor computing device, initiator computing device, beneficiary computing device, payment processor computing device, online fundraising service provider computing device, requests the disbursement computing device, or
in a payment disbursement process; and
displaying electronically, by the at least one computer processor, on a graphical user interface the transaction state of the electronic disbursement method.

6. A non-transitory computer readable medium having stored thereon instructions for causing one or more processing units to execute the method according to claim 5.

7. A computer-implemented method of electronically creating, electronically managing, and electronically hosting a plurality of online electronic fundraising campaigns and of providing for rapid distribution of funds, and transaction state of electronic initiation of electronic distribution of funds raised, comprising:
under control of a fundraising electronic social networking system of an online electronic fundraising service provider system of an online fundraising service provider,
wherein the fundraising electronic social networking system comprises:
at least one computer processor, and
at least one computer memory device, and
wherein the fundraising electronic social networking system is coupled to at least one electronic communications network, and wherein said at least one computer processor is configured to:
display, by the at least one electronic computer processor, a graphical user interface for at least one online electronic fundraising campaign;
initiate, by the at least one electronic computer processor, an electronic disbursement process of at least a portion of funds by at least one electronic transaction, initiated by the online electronic fundraising service provider; and
wherein the computer-implemented method comprises:
electronically receiving, by the at least one electronic computer processor, an electronic request to create at least one online electronic fundraising campaign from an electronic initiator social networking computing system of an initiator computing device of an initiator over the at least one electronic communications network,
wherein the initiator computing device of the initiator comprises at least one or more of: a) an individual initiator computing device not a non-profit entity, b) a group initiator computing device not a non-profit entity, or c) a for-profit initiator computing device,
for benefit of a beneficiary having a beneficiary computing device,
wherein the beneficiary computing device of the beneficiary comprises at least one or more of: a) an individual beneficiary computing device of a not a non-profit entity, b) a group beneficiary computing device of a not a non-profit entity, or c) a for-profit beneficiary computing device; and
wherein the electronic initiator social networking computing system comprises at least one or more of:
an electronic mobile device;
an electronic interactive television device;
a wired electronic communications device;
a wireless electronic communications device;
an electronic social networking system web-browser based system;
an electronic social networking computing system;
an electronic handheld social networking computing system;
an electronic telephony device; or
an electronic streaming technology device;
electronically creating, by the at least one electronic computer processor, at least one online electronic fundraising campaign page for the at least one created online electronic fundraising campaign for display on the graphical user interface, in response to said electronic request to create the online electronic fundraising campaign from the initiator for the benefit of the beneficiary having the beneficiary computing device;
electronically displaying, by the at least one electronic computer processor, the at least one online electronic fundraising campaign page on at least one graphical user interface;
electronically creating, by the at least one electronic computer processor, at least one online electronic social network wall, associated with the at least one created online electronic fundraising campaign and the at least one online electronic fundraising campaign page created,
wherein said at least one online electronic social network wall is configured to
electronically receive input in the at least one graphical user interface, by the at least one electronic computer processor, and
electronically provide for electronic display, by the at least one electronic computer processor on the at least one graphical user interface,
of any
online electronic computer social network wall posts electronically received, by the at least one electronic computer processor, over the electronic communication network from any of a plurality of electronic social networking system computing devices of each of a plurality of users to the at least one created online electronic fundraising campaign,
wherein each of the plurality of electronic social networking system computing devices comprise at least one or more of:
an electronic mobile device;
an electronic interactive television device;
a wired electronic communications device;
a wireless electronic communications device;
an electronic social networking system web-browser based program;
a handheld electronic social networking system computing device;
an electronic telephony device; or
a streaming technology device,
wherein the online electronic computer social network wall posts electronically received by the at least one electronic computer processor, comprise at least one or more of:
an electronic donor post comprising at least one or more of:
a social media wall post from a donor computing device to the at least one created online electronic fundraising campaign;
an electronic donation from the donor computing device;
an electronic computer social network wall post of a message of support from the donor computing device for the beneficiary computing device; or
an electronic computer social network wall post promoting the at least one created online electronic fundraising campaign;
at least one electronic computer social network wall post from at least one or more of:
the beneficiary computing device;
the initiator computing device;
a registered user computing device;
a user computing device;
a visitor computing device;
member of browsing public computing device; or
one or more of the donors computing devices;
an electronic beneficiary post comprising at least one or more of:
an online electronic computer social network wall post from the beneficiary computing device;
an online electronic computer social network wall post promoting the at least one created online fundraising campaign;
an online electronic computer social network wall post of an electronic message from the beneficiary computing device; or
an online electronic computer social network wall post of a thank you from the beneficiary computing device;
or
an electronic initiator post comprising at least one or more of:
an online electronic computer social network wall post from the initiator computing device;
an online electronic computer social network wall post promoting the at least one created online fundraising campaign;
an online electronic computer social network wall post of an electronic message from the initiator computing device;
an online electronic computer social network wall post of a thank you from the initiator computing device; or
an online electronic computer social network wall post of an electronic message of support from the initiator computing device of the at least one electronically created online electronic fundraising campaign;
electronically receiving, by the at least one electronic computer processor, data indicative of a plurality of funds from the plurality of electronic social networking system computing devices of the plurality of users, wherein each of the plurality of the electronic social networking system computing devices is coupled to the fundraising electronic social networking system of the online electronic fundraising service provider system by the at least one electronic communications network; and
electronically computing and electronically displaying, by the at least one electronic computer processor, on said at least one online electronic fundraising campaign page of the at least one electronically created online electronic fundraising campaign,
an online electronic computer displayable scoreboard associated with the at least one electronically created online electronic fundraising campaign,
wherein said online electronic computer displayable scoreboard comprises:
an online electronic computer displayable cumulative value of funds raised from the plurality of users computing devices of one or more of the at least one electronically created online electronic fundraising campaign,
wherein said online electronic computer displayable cumulative value is computed by at least one or more of: at least one threshold, a giving total, a frequency, or at least one particular time period comprising at least one or more of:
a day,
a week,
a month,
a year, or
a total time period; and
wherein said electronically displaying comprises:
electronically displaying, by the at least one electronic computer processor, on the graphical user interface said online electronic computer displayable cumulative value and said online electronic computer displayable scoreboard;
electronically enabling, by the at least one electronic computer processor, collecting from the initiator computing device or the beneficiary computing device disbursement information of the initiator or beneficiary to receive the at least a portion of funds electronically via the electronic disbursement process from the plurality of users computing devices of the at least one electronically created online electronic fundraising campaign;
electronically initiating the electronic disbursement process, by the at least one electronic computer processor, of the at least a portion of the funds raised electronically from the at least one electronically created online electronic fundraising campaign according to the disbursement information collected from the beneficiary computing device of the beneficiary or initiator computing device of the initiator;
wherein the initiating of the electronic disbursement process is performed at least one or more of:
electronically, by the at least one electronic computer processor, at least one or more of:
as soon as funds are received,
in a batch process at a later time,
at a periodic time interval,
at a time when the donor computing device, the initiator computing device, the beneficiary computing device, payment processor computing device, the online electronic fundraising service provider system, or recipient computing device requests the disbursement, or
in the payment disbursement process; or
electronically, by the at least one electronic computer processor, by electronic funds transfer (EFT), at least one or more of:
as soon as funds are received,
in a batch process at a later time,
at a periodic time interval,
at a time when the donor, initiator, beneficiary, payment processor, online electronic fundraising service provider, requests the disbursement, or in the payment disbursement process; and
wherein said electronically initiating of the electronic disbursement process comprises:
electronically displaying, by the at least one electronic computer processor, on the graphical user interface the transaction state of said initiation of said electronic disbursement, by the at least one electronic transaction;
electronically creating, by the at least one electronic computer processor, said online electronic computer displayable scoreboard comprises:
electronically displaying, by the at least one electronic computer processor, on the graphical user interface, by said at least one computer, at least one or more of:
an electronic computer displayable graphic element representative of; or
an electronic computer displayable text representation of,
said online electronic computer displayable cumulative value of said funds raised.

8. A data processing system comprising:
a fundraising service provider system coupled to an electronic communication network comprising:
at least one electronic computer processor, and at least one electronic computer memory coupled to said at least one electronic computer processor, said at least one computer processor configured to:
electronically receive a request from an initiator user electronic computer device to create at least one online electronic fundraising campaign to electronically raise funds for the benefit of a beneficiary user having a beneficiary user electronic computer device, from a plurality of users each having at least one electronic user computer device coupled to the electronic communication network, including receive from the initiator user, electronic disbursement information of the initiator user and the beneficiary user;
electronically create, in response to the request, the at least one online electronic fundraising campaign including:
electronically create an electronic fundraising campaign webpage,
electronically create a social network media wall for receipt of one or more fundraising wall posts from at least one of the plurality of at least one electronic user computer devices, and
electronically create an electronic scoreboard of cumulative giving;
electronically initiate an electronic disbursement process of at least a portion of the funds raised according to the user electronic disbursement information; and
electronically host the at least one online electronic fundraising campaign at the fundraising service provider system.

9. The system according to claim 1, wherein at least one of the initiator, or the beneficiary are at least one or more of:
a for profit business;
a for profit company;
a for profit corporation;
a for profit association;
a for profit individual;
a for profit person; or
a for profit group.

10. The system according to claim 9, wherein the donor is an investor, and the donation is an investment.

11. The system according to claim 1, wherein the donor is providing funds to a for profit business, and the donation is funds.
